(19) United States
(12) Patent Application Publication
(10) Pub. No.: US 2022/0231284 A1
(43) Pub. Date: Jul. 21, 2022

(54) ELECTRODE MATERIALS COMPRISING A LAYERED POTASSIUM METAL OXIDE, ELECTRODES COMPRISING THEM AND THEIR USE IN ELECTROCHEMISTRY

(71) Applicant: HYDRO-QUÉBEC, Montréal, Québec (CA)

(72) Inventors: Yuesheng WANG, Candiac (Québec) (CA); Abdelbast GUERFI, Brossard (Québec) (CA); Marc-André GIRARD, Montréal (Québec) (CA); Karim ZAGHIB, Longueuil, Québec (CA)

(73) Assignee: HYDRO-QUÉBEC, Montréal, Québec (CA)

(21) Appl. No.: 17/615,267

(22) PCT Filed: May 29, 2020
(86) PCT No.: PCT/CA2020/050735

§ 371 Date: Nov. 30, 2021

Related U.S. Application Data
(60) Provisional application No. 62/855,537, filed on May 31, 2019.

(51) Int. Cl. H01M 4/36; H01M 4/485; H01M 4/62; H01M 10/0525; H01M 10/054

(52) U.S. Cl. CPC H01M 4/366; H01M 4/485; H01M 4/625; H01M 2004/028; H01M 10/0525; H01M 10/054; H01M 4/623

(57) ABSTRACT

Electrode materials comprising an electrochemically active material, wherein said electrochemically active material comprises a layered potassium metal oxide. The layered potassium metal oxide may be of formula KₓMO₂. The invention also relates to electrodes, electrochemical cells and batteries comprising said electrode material. For example, said battery may be a lithium or lithium-ion battery, a sodium or sodium-ion battery, or a potassium or potassium-ion battery.

### RELATED APPLICATION

This application claims priority, under the applicable law, to U.S. Provisional Patent Application No. 62/855,537 filed on May 31, 2019, the content of which is incorporated herein by reference in its entirety and for all purposes.

### TECHNICAL FIELD

The present application relates to the field of electrochemically active materials and their uses in electrochemical applications. More particularly, the present application generally relates to electrode materials comprising a layered potassium metal oxide as an electrochemically active material, electrodes comprising them, their manufacturing processes and their use in electrochemical cells.

### BACKGROUND

All-solid-state batteries are an emerging solution for electric vehicle batteries or traction batteries for next-generation electric cars. Compared to conventional lithium-ion batteries using liquid electrolytes, all-solid-state batteries can generally be manufactured at lower cost, and can present an improved lifetime, faster charging times, higher performances, and higher safety.

Due to their higher theoretical capacity, and their potential to solve certain energy density problems associated with conventional lithium-ion batteries, batteries comprising lithium or sodium metal anodes have been revisited and improved to replace graphite anodes in high energy density storage systems.

However, the higher cost of conventional commercial cathode materials for lithium-ion batteries (for example, lithium cobalt dioxide (LiCoO₂) and lithium, nickel, manganese, and cobalt oxides (NMC) such as LiNi_{0.33}Mn_{0.33}Co_{0.33}O₂ (NMC 111), LiNi_{0.6}Mn_{0.2}Co_{0.2}O₂ (NMC 622) and LiNi_{0.8}Mn_{0.1}Co_{0.1}O₂ (NMC 811)), and the complex synthesis or production processes of lithium-free electrode materials, limit the adoption of all-solid-state batteries, especially in large-scale energy storage systems.

Accordingly, there is thus a need for the development of new electrode materials that exclude one or more of the disadvantages of conventional commercial cathode materials. For example, there is a need for low cost, high capacity, high-voltage materials for all-solid-state batteries.

### SUMMARY

According to one aspect, the present technology relates to an electrode material comprising an electrochemically active material, said electrochemically active material comprising a layered potassium metal oxide of formula KₓMO₂, wherein x is a number such that 0<x≤0.7, and M is selected from Co, Mn, Fe, Ni, Ti, Cr, V, Cu, Zr, Sb, and a combination of at least two thereof.

In one embodiment, the electrochemically active material comprises a layered potassium metal oxide of formula KₓM_{y}Mn_{1-y}O₂, wherein x is as herein defined, y is a number such that 0≤y≤1.0, and M is selected from Co, Fe, Ni, Ti, Cr, V, Cu, Zr, Sb, and a combination of at least two thereof. For example, the layered potassium metal oxide is of formula KₓFe_{y}Mn_{1-y}O₂, wherein x and y are as defined herein.

In another embodiment, the layered potassium metal oxide is of formula KₓNi_{0.5x}Mn_{1-0.5x}O₂, wherein x is as defined herein.

In another embodiment, the layered potassium metal oxide is of formula KₓNi_{0.5x}Mn_{1-0.5x-y}M_{y}O₂, wherein x is as defined herein, y is a number such that 0≤y≤(1.0−0.5x), and M is selected from Co, Fe, Ti, Cr, V, Cu, Zr, Sb, and a combination of at least two thereof. For example, the layered potassium metal oxide is of formula KₓNi_{0.5x}Mn_{1-0.5}Ti_{y}O₂, wherein x and y are as defined herein.

In another embodiment, the layered potassium metal oxide is selected from the group consisting of K_{0.67}N_{0.33}Mn_{0.67}O₂, K_{0.6}N_{0.3}Mn_{0.7}O₂, K_{0.5}N_{0.25}Mn_{0.75}O₂, K_{0.4}N_{0.2}Mn_{0.8}O₂, K_{0.4}Ni_{0.2}Mn_{0.6}Ti_{0.2}O₂, K_{0.4}Ni_{0.2}Mn_{0.7}Ti_{0.1}O₂, K_{0.4}Ni_{0.2}Mn_{0.75}Ti_{0.05}O₂, K_{0.4}Fe_{0.4}Mn_{0.6}O₂, K_{0.4}Ni_{0.1}Mn_{0.9}O₂, K_{0.4}MnO₂, K_{0.3}Ni_{0.15}Mn_{0.85}O₂, K_{0.3}Ni_{0.2}Mn_{0.8}O₂, K_{0.3}Mn_{0.2}, K_{0.2}Ni_{0.1}Mn_{0.9}O₂, K_{0.2}Ni_{0.2}Mn_{0.8}O₂, K_{0.2}MnO₂, K_{0.1}Ni_{0.05}Mn_{0.95}O₂, K_{0.1}Ni_{0.1}Mn_{0.9}O₂, and a combination of at least two of these.

According to another aspect, the present technology relates to an electrode material comprising an electrochemically active material, said electrochemically active material comprising a layered potassium metal oxide of formula Na_{z}KₓMO₂, wherein x is a number such that 0<x≤0.7, z is a number such that 0<x≤0.8, and M is selected from Co, Mn, Fe, Ni, Ti, Cr, V, Cu, Zr, Sb, and a combination of at least two thereof.

In one embodiment, the electrochemically active material comprises a layered potassium metal oxide of formula Na_{z}KₓM_{y}Mn_{1-y}O₂, wherein x and z are as herein defined, y is a number such that 0≤y≤1.0, and M is selected from Co, Fe, Ni, Ti, Cr, V, Cu, Zr, Sb, and a combination of at least two thereof.

In another embodiment, the layered potassium metal oxide is of formula Na_{z}KₓNi_{y}Mn_{1-y}O₂, wherein x and z are as herein defined, and y is a number such that 0≤y≤1.0.

In another embodiment, the layered potassium metal oxide is selected from the group consisting of Na_{0.74}K_{0.08}Ni_{0.41}Mn_{0.59}O₂, Na_{0.6}K_{0.08}Ni_{0.34}Mn_{0.66}O₂, Na_{0.74}K_{0.08}Ni_{0.2}Mn_{0.6}O₂, Na_{0.32}K_{0.06}Ni_{0.2}Mn_{0.6}O₂, Na_{0.2}K_{0.2}Ni_{0.2}Mn_{0.8}O₂, and a combination of at least two thereof.

In another embodiment, the electrode material further comprises an electronically conductive material. According to one example, the electronically conductive material is selected from the group consisting of carbon black, acetylene black, graphite, graphene, carbon fibers, carbon nanofibers, carbon nanotubes, and a combination of at least two thereof.

In another embodiment, the electrode material further comprises a binder. According to one example, the binder is selected from the group consisting of a polymeric binder of polyether type, a fluoropolymer, and a water-soluble binder.

According to another aspect, the present technology relates to an electrode comprising an electrode material as herein defined on a current collector.

In one embodiment, the electrode is a positive electrode.

According to another aspect, the present technology relates to an electrochemical cell comprising a negative electrode, a positive electrode, and an electrolyte, wherein the positive electrode is as herein defined.

In one embodiment, the negative electrode comprises lithium metal, sodium metal, potassium metal, or an alloy comprising at least one thereof.

In another embodiment, the negative electrode comprises at least one of a prelithiated alloy, a prelithiated graphite, a prelithiated silicon, a prelithiated oxide, or a combination of at least two thereof.

In another embodiment, the negative electrode comprises at least one of a presodiated alloy, a presodiated hard carbon and a presodiated oxide.

In another embodiment, the negative electrode comprises at least one of a prepotassiated alloy, a prepotassiated graphite, a prepotassiated hard carbon and a prepotassiated oxide.

In another embodiment, the electrolyte is a liquid electrolyte comprising a salt in a solvent.

In another embodiment, the electrolyte is a gel electrolyte comprising a salt in a solvent and optionally a solvating polymer.

In another embodiment, the electrolyte is a solid polymer electrolyte comprising a salt in a solvating polymer.

According to one example, the salt is selected from a lithium salt, a sodium salt, a potassium salt, and a combination of at least two thereof.

In another embodiment, the electrolyte is a glass or ceramic electrolyte. For example, the electrolyte is a glass or ceramic electrolyte selected from a site-deficient perovskite-type electrolyte, a garnet-type electrolyte, a NASICON-type glass ceramic electrolyte, a LISICON-type electrolyte, a lithium-stabilized sodium ion (Na⁺) conducting aluminum oxide (Al₂O₃), and other similar glass or ceramic electrolytes.

According to another aspect, the present technology relates to a battery comprising at least one electrochemical cell as herein defined.

In one embodiment, the battery is selected from the group consisting of a lithium battery, a lithium-ion battery, a sodium battery, a sodium-ion battery, a potassium battery, and a potassium-ion battery.

### BRIEF DESCRIPTION OF THE FIGURES

FIG. 1 shows in (A) an X-ray diffraction pattern for a layered potassium metal oxide powder of formula K_{0.67}Ni_{0.33}Mn_{0.67}O₂ obtained using the solid-state synthesis described in Example 1(a); and in (B) an illustration of the crystal structure and crystal structure characteristics for layered K_{0.67}Ni_{0.33}Mn_{0.67}O₂.

FIG. 2 shows in (A) an X-ray diffraction pattern for a layered potassium metal oxide powder of formula K_{0.6}Ni_{0.3}Mn_{0.7}O₂ obtained using the solid-state synthesis described in Example 1(a); and in (B) an illustration of the crystal structure and crystal structure characteristics for layered K_{0.6}Ni_{0.3}Mn_{0.7}O₂.

FIG. 3 shows in (A) an X-ray diffraction pattern for a layered potassium metal oxide powder of formula K_{0.5}Ni_{0.25}Mn_{0.75}O₂ obtained using the solid-state synthesis described in Example 1(a); and in (B) an illustration of the crystal structure and crystal structure characteristics for layered K_{0.5}Ni_{0.25}Mn_{0.75}O₂.

FIG. 4 shows in (A) an X-ray diffraction pattern for a layered potassium metal oxide powder of formula K_{0.4}Ni_{0.2}Mn_{0.8}O₂ obtained using the solid-state synthesis described in Example 1(a); and in (B) an illustration of the crystal structure and crystal structure characteristics for layered K_{0.4}Ni_{0.2}Mn_{0.8}O₂.

FIG. 5 shows in (A) an X-ray diffraction pattern for a layered potassium metal oxide powder of formula K_{0.4}Ni_{0.2}Mn_{0.6}Ti_{0.2}O₂ obtained using the solid-state synthesis described in Example 1(a); and in (B) two illustrations of the crystal structure for layered K_{0.4}Ni_{0.2}Mn_{0.6}Ti_{0.2}O₂.

FIG. 6 shows in (A) an X-ray diffraction pattern for a layered potassium metal oxide powder of formula K_{0.4}Ni_{0.2}Mn_{0.7}Ti_{0.1}O₂ obtained using the solid-state synthesis described in Example 1(a); and in (B) an illustration of the crystal structure and crystal structure characteristics for layered K_{0.4}Ni_{0.2}Mn_{0.7}Ti_{0.1}O₂.

FIG. 7 shows in (A) an X-ray diffraction pattern for a layered potassium metal oxide powder of formula K_{0.4}Ni_{0.2}Mn_{0.75}Ti_{0.05}O₂ obtained using the solid-state synthesis described in Example 1(a); and in (B) an illustration of the crystal structure and characteristics of the crystal structure for layered K_{0.4}Ni_{0.2}Mn_{0.75}Ti_{0.05}O₂.

FIG. 8 shows in (A) an X-ray diffraction pattern for a layered potassium metal oxide powder of formula K_{0.4}Fe_{0.4}Mn_{0.6}O₂ obtained using the solid-state synthesis described in Example 1(a); and in (B) an illustration of the crystal structure and characteristics of the crystal structure for layered K_{0.4}Fe_{0.4}Mn_{0.6}O₂.

FIG. 9 shows in (A) an X-ray diffraction pattern for a layered potassium metal oxide powder of formula K_{0.4}Ni_{0.1}Mn_{0.9}O₂ obtained using the solid-state synthesis described in Example 1(a); and in (B) and (C) an illustration of the crystal structure and characteristics of the crystal structure for layered K_{0.4}Ni_{0.1}Mn_{0.9}O₂.

FIG. 10 shows in (A) an X-ray diffraction pattern for a layered potassium metal oxide powder of formula K_{0.4}MnO₂ obtained using the solid-state synthesis described in Example 1(a); and in (B) an illustration of the crystal structure and characteristics of the crystal structure for layered K_{0.4}MnO₂.

FIG. 11 shows in (A) an X-ray diffraction pattern for a layered potassium metal oxide powder of formula K_{0.3}Ni_{0.15}Mn_{0.85}O₂ obtained using the solid-state synthesis described in Example 1(a); and in (B) an illustration of the crystal structure and crystal structure characteristics for layered K_{0.3}Ni_{0.15}Mn_{0.85}O₂.

FIG. 12 shows in (A) an X-ray diffraction pattern for a layered potassium metal oxide powder of formula K_{0.3}Ni_{0.2}Mn_{0.8}O₂ obtained using the solid-state synthesis described in Example 1(a); and in (B) an illustration of the crystal structure and crystal structure characteristics for layered K_{0.3}Ni_{0.2}Mn_{0.8}O₂.

FIG. 13 shows in (A) an X-ray diffraction pattern for a layered potassium metal oxide powder of formula K_{0.3}MnO₂ obtained using the solid-state synthesis described in Example 1(a); and in (B) an illustration of the crystal structure and crystal structure characteristics for layered K_{0.3}Mn_{0.2}.

FIG. 14 shows in (A) an X-ray diffraction pattern for a layered potassium metal oxide powder of formula K_{0.2}Ni_{0.1}Mn_{0.9}O₂ obtained using the solid-state synthesis described in Example 1(a); and in (B) and (C) an illustration of the crystal structure and characteristics of the crystal structure for layered K_{0.2}Ni_{0.1}Mn_{0.9}O₂.

FIG. 15 shows in (A) an X-ray diffraction pattern for a layered potassium metal oxide powder of formula K_{0.2}Ni_{0.2}Mn_{0.8}O₂ obtained using the solid-state synthesis described in Example 1(a); and in (B) an illustration of the crystal structure and crystal structure characteristics for layered K_{0.2}Ni_{0.2}Mn_{0.8}O₂.

FIG. 16 shows in (A) an X-ray diffraction pattern for a layered potassium metal oxide powder of formula K_{0.2}MnO₂ obtained using the solid-state synthesis described in Example 1(a); and in (B) the crystal structure characteristics for layered K_{0.2}MnO₂.

FIG. 17 shows in (A) an X-ray diffraction pattern for a layered potassium metal oxide powder of formula K_{0.1}Ni_{0.05}Mn_{0.95}O₂ obtained using the solid-state synthesis described in Example 1(a); and in (B) an illustration of the crystal structure and crystal structure characteristics for layered K_{0.1}Ni_{0.05}Mn_{0.95}O₂.

FIG. 18 shows X-ray diffraction patterns for layered potassium metal oxide powders of formulae Na_{0.74}K_{0.08}Ni_{0.41}Mn_{0.59}O₂ (black line), Na_{0.6}K_{0.08}Ni_{0.34}Mn_{0.66}O₂ (red line), Na_{0.74}K_{0.08}Ni_{0.2}Mn_{0.8}O₂ (blue line), Na_{0.6}K_{0.08}Ni_{0.2}Mn_{0.8}O₂ (pink line), Na_{0.32}K_{0.08}Ni_{0.2}Mn_{0.8}O₂ (burgundy line), and Na_{0.2}K_{0.2}Ni_{0.2}Mn_{0.8}O₂ (orange line) obtained using the solid-state synthesis described in Example 1(a).

FIG. 19 is a graph of the capacity (mAh·g⁻¹) versus x for a layered potassium metal oxide of formula KₓNi_{0.5x}Mn_{1-0.5x}O₂ (where, x is a number such that 0.1≤x≤0.7), as described in Example 3(b). Results are presented for a lithium-ion battery (red line) and for a sodium-ion battery (black line).

FIG. 20 shows in (A) two charge and discharge profiles for Cell 1 recorded at a cycling rate of 0.1 C between 1.5 V and 4.5 V vs. Li⁺/Li; and in (B) two charge and discharge profiles for Cell 2 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 21 shows in (A) two charge and discharge profiles for Cell 3 recorded at a cycling rate of 0.1 C between 1.5 V and 4.5 V vs. Li⁺/Li; and in (B) two charge and discharge profiles for Cell 4 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 22 shows in (A) two charge and discharge profiles for Cell 5 recorded at a cycling rate of 0.1 C between 1.5 V and 4.5 V vs. Li⁺/Li; and in (B) two charge and discharge profiles for Cell 6 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 23 shows in (A) two charge and discharge profiles for Cell 7 recorded at a cycling rate of 0.1 C between 1.5 V and 4.5 V vs. Li⁺/Li; and in (B) two charge and discharge profiles for Cell 8 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 24 shows in (A) two charge and discharge profiles for Cell 9 recorded at a cycling rate of 0.1 C between 1.5 V and 4.5 V vs. Li⁺/Li; and in (B) two charge and discharge profiles for Cell 10 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 25 shows in (A) two charge and discharge profiles for Cell 11 recorded at a cycling rate of 0.1 C between 1.5 V and 4.5 V vs. Li⁺/Li; and in (B) two charge and discharge profiles for Cell 12 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 26 shows in (A) two charge and discharge profiles for Cell 13 recorded at a cycling rate of 0.1 C between 1.5 V and 4.5 V vs. Li⁺/Li; and in (B) two charge and discharge profiles for Cell 14 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 27 shows in (A) two charge and discharge profiles for Cell 15 recorded at a cycling rate of 0.1 C between 1.5 V and 4.5 V vs. Li⁺/Li; and in (B) two charge and discharge profiles for Cell 16 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 28 shows in (A) two charge and discharge profiles for Cell 17 recorded at a cycling rate of 0.1 C between 1.5 V and 4.5 V vs. Li⁺/Li; and in (B) two charge and discharge profiles for Cell 18 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 29 shows in (A) two charge and discharge profiles for Cell 19 recorded at a cycling rate of 0.1 C between 1.5 V and 4.5 V vs. Li⁺/Li; and in (B) two charge and discharge profiles for Cell 20 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 30 shows in (A) two charge and discharge profiles for Cell 21 recorded at a cycling rate of 0.1 C between 1.5 V and 4.5 V vs. Li⁺/Li; and in (B) two charge and discharge profiles for Cell 22 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 31 shows in (A) two charge and discharge profiles for Cell 23 recorded at a cycling rate of 0.1 C between 1.5 V and 4.5 V vs. Li⁺/Li; and in (B) two charge and discharge profiles for Cell 24 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 32 shows in (A) two charge and discharge profiles for Cell 25 recorded at a cycling rate of 0.1 C between 1.5 V and 4.5 V vs. Li⁺/Li; and in (B) two charge and discharge profiles for Cell 26 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 33 shows in (A) two charge and discharge profiles for Cell 27 recorded at a cycling rate of 0.1 C between 1.5 V and 4.5 V vs. Li⁺/Li; and in (B) two charge and discharge profiles for Cell 28 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 34 shows in (A) two charge and discharge profiles for Cell 29 recorded at a cycling rate of 0.1 C between 1.5 V and 4.5 V vs. Li⁺/Li; and in (B) two charge and discharge profiles for Cell 30 recorded at a cycling rate of 0.1 C between 1.5 V and 4.2 V vs. Na⁺/Na, as described in Example 3(b). Results are shown for a first (black line, 1) and second (red line, 2) discharge and charge cycle.

FIG. 35 shows three charge and discharge profiles for Cell 33 recorded at a cycling rate of 0.1 C between 1.5 V and 4.2 V vs. Na⁺/Na, as described in Example 3(b). Results are shown for a first (black line, 1), second (red line, 2), and third (blue line, 3) discharge and charge cycle.

FIG. 36 shows three charge and discharge profiles for Cell 34 recorded at a cycling rate of 0.1 C between 1.5 V and 4.2 V vs. Na⁺/Na, as described in Example 3(b). Results are shown for a first (black line, 1), second (red line, 2), and third (blue line, 3) discharge and charge cycle.

FIG. 37 shows three charge and discharge profiles for Cell 35 recorded at a cycling rate of 0.1 C between 1.5 V and 4.2 V vs. Na⁺/Na, as described in Example 3(b). Results are shown for a first (black line, 1), second (red line, 2), and third (blue line, 3) discharge and charge cycle.

FIG. 38 shows a graph of the capacity (mAh·g⁻¹) and efficiency (%) versus the number of cycles recorded in (A) for Cells 1, 3, 5, 17, 19, 25 and 31 (lithium-ion); and in (B) for Cells 2, 4, 6, 18, 26 and 32 (sodium-ion), as described in Example 3(b).

FIG. 39 is a table of reflection parameters of a layered potassium metal oxide having the crystal structure characteristics presented in Table 1, as described in Example 2(b).

FIG. 40 is a table of reflection parameters of a layered potassium metal oxide having the crystal structure characteristics presented in Table 2, as described in Example 2(b).

FIG. 41 is a table of reflection parameters of a layered potassium metal oxide having the crystal structure characteristics presented in Table 3, as described in Example 2(b).

### DETAILED DESCRIPTION

The following detailed description and examples are presented for illustrative purposes only and should not be construed as further limiting the scope of the invention.

All technical and scientific terms and expressions used herein have the same definitions as those commonly understood by the person skilled in the art of the present technology. The definition of some terms and expressions used is nevertheless provided below.

When the term “approximately” or its equivalent term “about” are used herein, it means in the region of, or around. For example, when the terms “approximately” or “about” are used in relation to a numerical value, they modify it above and below by a 10% variation compared to the nominal value. This term can also take into account, for example, the experimental error of a measuring device or rounding.

When a range of values is mentioned in the present application, the lower and upper limits of the range are, unless otherwise specified, always included in the definition.

The present technology relates to electrode materials comprising a layered potassium oxide and at least one metallic element as electrochemically active materials, their methods of production and their use in electrochemical cells, for example, in lithium-ion batteries, sodium-ion batteries or potassium-ion batteries.

According to one example, the present technology relates to an electrode material including an electrochemically active material, wherein said electrochemically active material includes a layered potassium metal oxide of formula KₓMO₂, wherein x is a number such that 0<x≤0.7, and M is selected from Na, Li, Co, Mn, Fe, Ni, Ti, Cr, V, Cu, Zn, Mg, Zr, Sb, and a combination of at least two thereof.

According to another example, the electrochemically active material includes a layered potassium metal oxide of formula KₓMO₂, wherein x is a number such that 0<x≤0.7, and M is selected from Co, Mn, Fe, Ni, Ti, Cr, V, Cu, Zr, Sb, and a combination of at least two thereof.

According to another example, the electrochemically active material may include a layered potassium metal oxide of formula KₓM_{y}Mn_{1-y}O₂, wherein x is as herein defined, y is a number such that 0≤y≤1.0, and M is selected from Na, Li, Co, Fe, Ni, Ti, Cr, V, Cu, Zn, Mg, Zr, Sb, and a combination of at least two thereof. According to one example, M may be selected from Co, Fe, Ni, Ti, Cr, V, Cu, Zr, Sb, and a combination of at least two thereof. For example, the electrochemically active material may include a layered potassium metal oxide of formula KₓFe_{y}Mn_{1-y}O₂, wherein y is as defined herein.

According to another example, the electrochemically active material may include a layered potassium metal oxide of formula KₓNi_{0.5x}Mn_{1-0.5x}O₂, wherein x is as defined herein.

According to another example, the electrochemically active material may include a layered potassium metal oxide of formula KₓNi_{0.5x}Mn_{1-0.5x-y}M_{y}O₂, wherein x is as herein defined, y is a number such that 0≤y≤(1.0-0.5x), and M is selected from Na, Li, Co, Fe, Ti, Cr, V, Cu, Zn, Mg, Zr, Sb, and a combination of at least two thereof. According to one example, M is selected from Co, Fe, Ti, Cr, V, Cu, Zr, Sb, and a combination of at least two thereof. For example, the electrochemically active material may include a layered potassium metal oxide of formula KₓNi_{0.5x}Mn_{1-0.5x}Ti_{y}O₂, wherein x and y are as defined herein. For example, the electrochemically active material may include a layered potassium metal oxide of formula K_{0.4}Ni_{0.2}Mn_{0.8-y}Ti_{y}O₂, wherein y is a number such that 0≤y≤0.8.

According to another example, the electrochemically active material includes a layered potassium metal oxide of formula Na_{z}KₓMO₂, wherein x is as herein defined, z is a number such that 0<x≤0.8, and M is selected from Li, Co, Mn, Fe, Ni, Ti, Cr, V, Cu, Zn, Mg, Zr, Sb, and a combination of at least two thereof.

According to another example, the electrochemically active material includes a layered potassium metal oxide of formula Na_{z}KₓMO₂, wherein x and z are as herein defined, and M is selected from Co, Mn, Fe, Ni, Ti, Cr, V, Cu, Zr, Sb, and a combination of at least two thereof.

According to another example, the electrochemically active material may include a layered potassium metal oxide of formula Na_{z}KₓM_{y}Mn_{1-y}O₂, wherein x and z are as herein defined, y is a number such that 0≤y≤1.0, and M is selected from Li, Co, Fe, Ni, Ti, Cr, V, Cu, Zn, Mg, Zr, Sb, and a combination of at least two thereof. According to one example, M may be selected from Co, Fe, Ni, Ti, Cr, V, Cu, Zr, Sb, and a combination of at least two thereof. For example, the electrochemically active material may include a layered potassium metal oxide of formula Na_{z}KₓNi_{y}Mn_{1-y}O₂, wherein x, y, and z are as defined herein.

According to another example, the electrochemically active material may include a layered potassium metal oxide of formulae KₓMnO₂, KₓNiMnO₂, KₓNiMnTiO₂, or KₓFeMnO₂, wherein x is as defined herein. Non-limiting examples of layered potassium metal oxides include K_{0.67}N_{0.33}Mn_{0.67}O₂, K_{0.6}Ni_{0.3}Mn_{0.7}O₂, K_{0.5}Ni_{0.25}Mn_{0.75}O₂, K_{0.4}Ni_{0.2}Mn_{0.8}O₂, K_{0.4}Ni_{0.2}Mn_{0.6}Ti_{0.2}O₂, K_{0.4}Ni_{0.2}Mn_{0.7}Ti_{0.1}O₂, K_{0.4}Ni_{0.2}Mn_{0.75}Ti_{0.05}O₂, K_{0.4}Fe_{0.4}Mn_{0.6}O₂, K_{0.4}Ni_{0.1}Mn_{0.9}O₂, K_{0.4}MnO₂, K_{0.3}Ni_{0.15}Mn_{0.85}O₂, K_{0.3}Ni_{0.2}Mn_{0.8}O₂, K_{0.3}MnO₂, K_{0.2}Ni_{0.1}Mn_{0.9}O₂, K_{0.2}Ni_{0.2}Mn_{0.8}O₂, K_{0.2}MnO₂, K_{0.1}Ni_{0.05}Mn_{0.95}O₂, K_{0.1}Ni_{0.1}Mn_{0.9}O₂, Na_{0.74}K_{0.08}Ni_{0.41}Mn_{0.59}O₂, Na_{0.6}K_{0.08}Ni_{0.34}Mn_{0.66}O₂, Na_{0.74}K_{0.08}Ni_{0.2}Mn_{0.8}O₂, Na_{0.6}K_{0.08}Ni_{0.2}Mn_{0.8}O₂, Na_{0.32}K_{0.08}Ni_{0.2}Mn_{0.8}O₂, and Na_{0.2}K_{0.2}Ni_{0.2}Mn_{0.8}O₂.

The electrochemically active material may optionally be doped with other elements or impurities included in smaller amounts, for example to modulate or optimize its electrochemical properties. In some cases, the electrochemically active material may be doped by the partial substitution of the metal with other ions. For example, the electrochemically active material may be doped with a transition metal (e.g., Fe, Co, Ni, Mn, Ti, Cr, Cu, V, Zn, and/or Y) and/or a metal other than a transition metal (e.g., Mg, Al, and/or Sb).

The electrode material may be substantially free of lithium and/or sodium. For example, the electrochemically active material may include less than 2 wt. %, less than 1 wt. %, less than 0.5 wt. %, less than 0.1 wt. %, less than 0.05 wt. %, or less than 0.01 wt. % of lithium and/or sodium. For example, the electrochemically active material may be delithiated and/or desodiated.

According to another example, the electrochemically active material may be in the form of particles (for example, microparticles, or nanoparticles) which may be freshly formed and may further include a coating material. The coating material may be an electronically conductive material, for example, a carbon coating.

According to another example, the electrode material as described herein may further include an electronically conductive material. Non-limiting examples of electronically conductive materials include a carbon source such as carbon black (for example, Ketjen™ carbon, or Super P™ carbon), acetylene black (for example, Shawinigan carbon, or Denka™ carbon black), graphite, graphene, carbon fibers (for example, vapor grown carbon fibers (VGCFs)), carbon nanofibers, carbon nanotubes (CNTs), or a combination of at least two thereof. According to one embodiment of interest, the electronically conductive material is selected from Ketjen™ carbon, Super P™ carbon, VGCFs, and a combination thereof.

According to another example, the electrode material as described herein may also include a binder. For example, the binder may be selected for its compatibility with the various elements of an electrochemical cell. Any known compatible binder is contemplated. For example, the binder may be a fluorinated polymer binder, a water-soluble (hydrosoluble) binder, or an ion-conductive polymer binder, such as copolymers composed of at least one lithium ion solvating segment, such as a polyether, and optionally at least one cross-linkable segment (for example, poly(ethylene oxide) (PEO)-based polymers including methyl methacrylate units). According to one example, the binder is a fluorinated polymer such as polyvinylidene fluoride (PVDF) or polytetrafluoroethylene (PTFE). According to another example, the binder is a water-soluble binder such as styrene-butadiene rubber (SBR), acrylonitrile-butadiene rubber (NBR), hydrogenated NBR (HNBR), epichlorohydrin rubber (CHR), or acrylate rubber (ACM), and optionally comprising a thickening agent such as carboxymethyl cellulose (CMC), or a polymer such as poly(acrylic acid) (PAA), poly(methacrylic acid) (PMMA), or a combination thereof.

According to another example, the binder is a polymeric binder of polyether type. For example, the polymeric binder of polyether type is linear, branched, and/or crosslinked and is based on PEO, poly(propylene oxide) (PPO), or a combination thereof (such as an EO/PO copolymer), and optionally includes cross-linkable units. According to one embodiment of interest, the binder is PVDF, or a polyether type polymer as defined herein.

The electrode material as described herein may further comprise additional components or additives such as inorganic particles, glass or ceramic particles, ionic conductors, salts, and other similar additives.

The present technology also relates to an electrode including the electrode material as defined herein on a current collector (for example, aluminum or copper foil). Alternatively, the electrode may be self-supported. According to one embodiment of interest, the electrode is a positive electrode.

The present technology also relates to an electrochemical cell including a negative electrode, a positive electrode and an electrolyte, wherein the positive electrode is as herein defined.

According to one example, the negative electrode (counter electrode) includes an electrochemically active material selected from all known compatible electrochemically active materials. For example, the electrochemically active material of the negative electrode may be selected for its electrochemical compatibility with the various elements of the electrochemical cell as herein defined.

Non-limiting examples of electrochemically active materials of the negative electrode include alkali metals, alkali metal alloys, prelithiated electrochemically active materials, presodiated electrochemically active materials, and prepotassiated electrochemically active materials. According to one example, the electrochemically active material of the negative electrode may be lithium metal, sodium metal, potassium metal, or an alloy including at least one of these. According to another example, the electrochemically active material of the negative electrode may be a prelithiated alloy, a prelithiated graphite, a prelithiated silicon, a prelithiated oxide, or a combination thereof when compatible. According to another example, the electrochemically active material of the negative electrode may be a presodiated alloy, presodiated hard carbon, or a presodiated oxide. According to another example, the electrochemically active material of the negative electrode may be a prepotassiated alloy, prepotassiated graphite, prepotassiated hard carbon, or prepotassiated oxide.

According to another example, the electrolyte may also be selected for its compatibility with the various elements of the electrochemical cell. Any type of compatible electrolyte is contemplated. According to one example, the electrolyte may be a liquid electrolyte including a salt in a solvent. According to one alternative, the electrolyte may be a gel electrolyte including a salt in a solvent and optionally a solvating polymer. According to another alternative, the electrolyte may be a solid polymer electrolyte including a salt in a solvating polymer. According to another alternative, the electrolyte may be a glass or ceramic electrolyte. According to one embodiment of interest, the electrolyte is a solvent-free solid polymer electrolyte, a glass electrolyte, or a ceramic electrolyte.

The salt, if present in the electrolyte, may be a metal salt, such as a lithium salt, a sodium salt, or a potassium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (Li FAP), lithium tetrakis(trifluoroacetoxy)borate Li[B(OCOCF₃)₄] (LiTFAB), lithium bis(1,2-benzenediolato(2-)-O,O′)borate [B(C₆O₂)₂] (LiBBB), and combinations thereof. According to one embodiment of interest, the lithium salt is LiPF₆, LiFSI, LiTFSI, or LiTDI. Non-limiting examples of sodium salts include sodium hexafluorophosphate (NaPF₆), sodium perchlorate (NaClO₄), sodium bis (trifluoromethanesulfonyl) imide (NaTFSI), sodium bis(fluorosulfonyl)imide (NaFSI), sodium 2-trifluoromethyl-4,5-dicyanoimidazolate (NaTDI), sodium bis (pentafluoroethylsulfonyl) imide (NaBETI), sodium trifluoromethanesulfonate (NaTF), sodium fluoride (NaF), sodium nitrate (NaNO₃), and a combination thereof. According to one embodiment of interest, the sodium salt is NaPF₆, NaFSI, NaTFSI, or NaClO₄. Non-limiting examples of potassium salts include potassium hexafluorophosphate (KPF₆), potassium bis (trifluoromethanesulfonyl) imide (KTFSI), potassium bis(fluorosulfonyl)imide (KFSI), potassium trifluoromethanesulfonate (KSO₃CF₃) (KTf), and a combination thereof. According to one embodiment of interest, the potassium salt is KPF₆.

The solvent, if present in the electrolyte, may be a non-aqueous solvent. Non-limiting examples of non-aqueous solvents include cyclic carbonates, such as ethylene carbonate (EC), propylene carbonate (PC), butylene carbonate (BC), and vinylene carbonate (VC); acyclic carbonates, such as dimethyl carbonate (DMC), diethyl carbonate (DEC), ethylmethyl carbonate (EMC), and dipropyl carbonate (DPC); lactones, such as γ-butyrolactone (γ-BL) and γ-valerolactone (γ-VL); chain ethers, such as 1,2-dimethoxyethane (DME), 1,2-diethoxyethane (DEE), and ethoxymethoxyethane (EME); cyclic ethers, such as tetrahydrofuran, 2-methyltetrahydrofuran, 1,3-dioxolane, and dioxolane derivatives; and other solvents such as dimethylsulfoxide, formamide, acetamide, dimethylformamide, acetonitrile, propylnitrile, nitromethane, phosphoric acid triesters, sulfolane, methylsulfolane, propylene carbonate derivatives, and mixtures thereof.

According to one example, the electrolyte comprises a salt selected from lithium hexafluorophosphate (LiPF₆), sodium hexafluorophosphate (NaPF₆), sodium perchlorate (NaClO₄) or potassium hexafluorophosphate (KPF₆) dissolved in a non-aqueous solvent mixture such as a mixture of ethylene carbonate and diethyl carbonate (EC/DEC) ([3:7] by volume), ethylene carbonate and dimethyl carbonate (EC/DMC) ([4:6] by volume), or dissolved in dimethyl carbonate (DMC), or propylene carbonate.

According to one example, the electrolyte is a liquid electrolyte, and the electrode material comprises an electrochemically active material, an electronically conductive material and a binder in a composition ratio of about 80:10:10. For example, the electrode material comprises about 80 wt. % of the electrochemically active material, about 10 wt. % of the electronically conductive material and about 10 wt. % of the binder.

When the electrolyte is a gel electrolyte or a gel polymer electrolyte. The gel polymer electrolyte may include, for example, a polymer precursor and a salt (for example, a salt as previously defined), a solvent (for example, a solvent as previously defined), and a polymerization and/or crosslinking initiator, if necessary. Non-limiting examples of gel electrolytes include, without limitation, the gel electrolytes described in PCT patent application published under numbers WO2009/111860 (Zaghib et al.) and WO2004/068610 (Zaghib et al.).

The electrolyte may also be a solid polymer electrolyte. For example, the solid polymer electrolyte may be selected from any known solid polymer electrolyte and may be selected for its compatibility with the various elements of the electrochemical cell. For example, the solid polymer electrolyte may be selected for its compatibility with lithium, sodium, and/or potassium. Solid polymer electrolytes generally include a salt as well as one or more solid polar polymer(s), optionally cross-linked. Polyether-type polymers, such as those based on PEO, may be used, but several other compatible polymers are also known for the preparation of solid polymer electrolytes and are also contemplated. The polymer may be cross-linked. Examples of such polymers include branched polymers, for example, star polymers or comb polymers such as those described in PCT patent application published as WO2003/063287 (Zaghib et al.).

According to one example, the electrolyte is a solid polymer electrolyte including a salt in a solvating polymer. According to an embodiment of interest, the polymer of the solid polymer electrolyte is PEO and the salt is LiTFSI, LiFSI, LiTDI, NaTFSI, or NaFSI.

According to another example, the electrolyte is a solid polymer electrolyte and the electrode material comprises from about 50 wt. % to about 75 wt. % of the electrochemically active material, from about 1 wt. % to about 5 wt. % of the electronically conductive material, and from about 20 wt. % to about 49 wt. % binder.

According to another example, the electrolyte is a ceramic electrolyte. For example, the ceramic electrolyte may include a crystalline ion conductive ceramic or an amorphous ion conductive ceramic (for example, an amorphous ion conductive glass) or an ion conductive glass ceramic. Non-limiting examples of glass or ceramic electrolytes include site-deficient perovskite-type electrolytes, garnet-type electrolytes, NASICON-type glass ceramic electrolytes, LISICON-type electrolytes, lithium-stabilized sodium ion (Na⁺) conducting aluminum oxides (Al₂O₃), and other similar glass or ceramic electrolytes.

A gel electrolyte or liquid electrolyte as previously defined may also impregnate a separator such as a polymer separator. Non-limiting examples of separators include polyethylene (PE), polypropylene (PP), cellulose, polytetrafluoroethylene (PTFE), polyvinylidene fluoride (PVDF) and polypropylene-polyethylene-polypropylene (PP/PE/PP) membranes. For example, the separator is a commercial polymer separator of the Celgard™ type.

The electrolyte may also optionally comprise additional components or additives such as ionic conductors, inorganic particles, glass or ceramic particles, for example, nanoceramics (such as Al₂O₃, TiO₂, SiO₂, and other similar compounds) and other such additives.

The present technology also relates to a battery comprising at least one electrochemical cell as herein defined. For example, the battery may be a lithium battery, a lithium-ion battery, a sodium battery, a sodium-ion battery, a potassium battery, or a potassium-ion battery.

According to at least one example, the battery is a lithium battery or a lithium-ion battery. According to one example, the electrolyte is a liquid electrolyte as herein defined and the electrochemically active material of the negative electrode comprises lithium metal, a lithium-based alloy, a prelithiated alloy, a prelithiated graphite, a prelithiated silicon, or a prelithiated oxide. According to another example, the electrolyte is a gel electrolyte as herein defined and the electrochemically active material of the negative electrode comprises lithium metal, a lithium-based alloy, a prelithiated alloy, a prelithiated graphite, or a prelithiated silicon. According to another example, the electrolyte is a solid polymer electrolyte, and the electrochemically active material of the negative electrode comprises lithium metal, a lithium-based alloy, a prelithiated graphite, or a prelithiated silicon. According to another example, the electrolyte is a ceramic electrolyte and the electrochemically active material of the negative electrode comprises lithium metal, a lithium-based alloy, or a prelithiated graphite, and/or a prelithiated silicon.

According to at least one example, the battery is a sodium battery or a sodium-ion battery. According to one example, the electrolyte is a liquid electrolyte as herein defined and the electrochemically active material of the negative electrode comprises sodium metal, a sodium-based alloy, a presodiated alloy, a presodiated hard carbon, or a presodiated oxide. According to another example, the electrolyte is a gel electrolyte as defined herein and the electrochemically active material of the negative electrode comprises sodium metal, a sodium-based alloy, a presodiated alloy, or presodiated hard carbon. According to another example, the electrolyte is a solid polymer electrolyte and the electrochemically active material of the negative electrode comprises sodium metal, a sodium-based alloy, or presodiated hard carbon. According to another example, the electrolyte is a ceramic electrolyte and the electrochemically active material of the negative electrode comprises sodium metal, a sodium-based alloy, or a presodiated hard carbon.

According to at least one example, the battery is a potassium battery or a potassium-ion battery. According to one example, the electrolyte is a liquid electrolyte as herein defined and the electrochemically active material of the negative electrode comprises potassium metal, a potassium-based alloy, a prepotassiated alloy, a prepotassiated graphite, a prepotassiated hard carbon, or a prepotassiated oxide. According to another example, the electrolyte is a gel electrolyte as herein defined and the electrochemically active material of the negative electrode comprises potassium metal, a potassium-based alloy, a prepotassiated alloy, a prepotassiated graphite, or a prepotassiated hard carbon. According to another example, the electrolyte is a solid polymer electrolyte and the electrochemically active material of the negative electrode comprises potassium metal, a potassium-based alloy, a prepotassiated graphite, or a prepotassiated hard carbon. According to another example, the electrolyte is a ceramic electrolyte and the electrochemically active material of the negative electrode comprises potassium metal, a potassium-based alloy, a prepotassiated graphite, or a prepotassiated hard carbon.

The present technology also relates to a layered potassium metal oxide that is in crystalline form and of formula KₓMO₂, wherein x is a number such that 0<x≤0.7, and M is selected from Li, Co, Mn, Fe, Ni, Ti, Cr, V, Cu, Zn, Mg, Zr, Sb and combinations thereof.

The present technology also relates to a layered potassium metal oxide that is in crystalline form and of formula KₓMO₂, wherein x is a number such that 0<x≤0.7, and M is selected from Co, Mn, Fe, Ni, Ti, Cr, V, Cu, Zr, Sb, and combinations thereof.

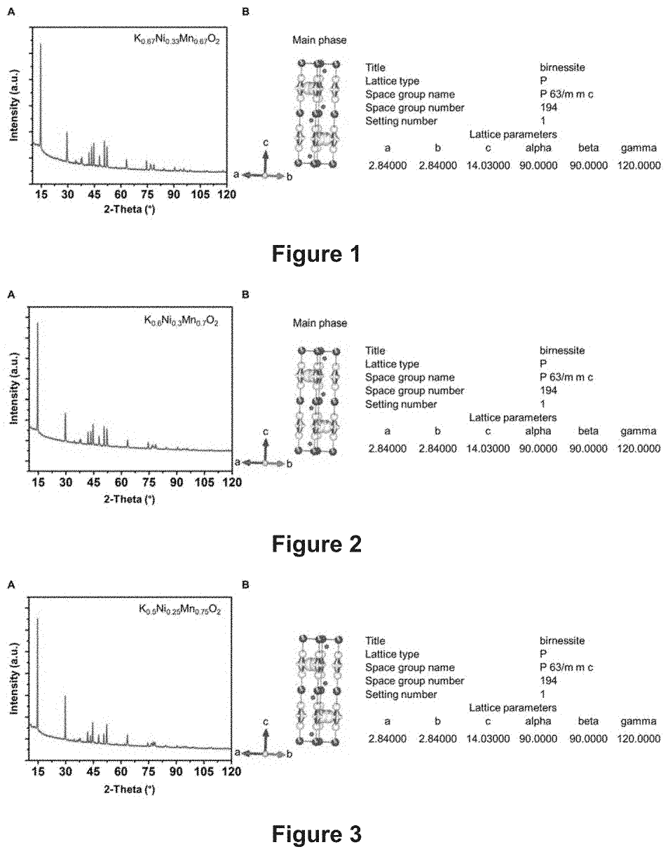

According to at least one example, the layered potassium metal oxide in crystalline form is of formula K_{0.67}Ni_{0.33}Mn_{0.67}O₂ and has an XRD pattern substantially as shown in FIG. 1.

According to another alternative, the layered potassium metal oxide in crystalline form is of formula K_{0.6}Ni_{0.3}Mn_{0.7}O₂ and has an XRD pattern substantially as shown in FIG. 2.

According to another alternative, the layered potassium metal oxide in crystalline form is of formula K_{0.5}Ni_{0.25}Mn_{0.75}O₂ and has an XRD pattern substantially as shown in FIG. 3.

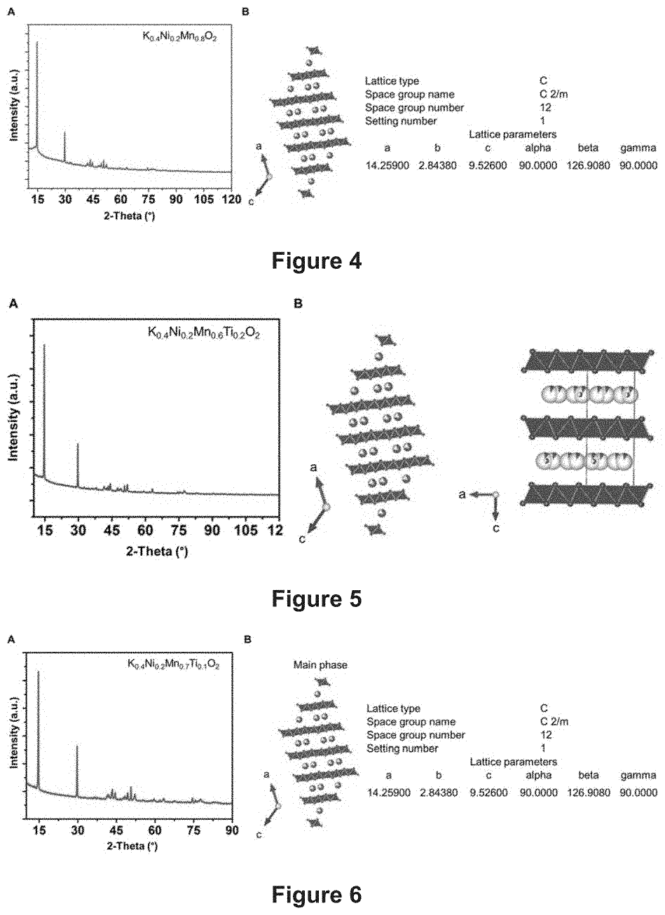

According to another alternative, the layered potassium metal oxide in crystalline form is of formula K_{0.4}Ni_{0.2}Mn_{0.8}O₂ and has an XRD pattern substantially as shown in FIG. 4.

According to another alternative, the layered potassium metal oxide in crystalline form is of formula K_{0.4}Ni_{0.2}Mn_{0.6}Ti_{0.2}O₂ and has an XRD pattern substantially as shown in FIG. 5.

According to another alternative, the layered potassium metal oxide in crystalline form is of formula K_{0.4}Ni_{0.2}Mn_{0.7}Ti_{0.1}O₂ and has an XRD pattern substantially as shown in FIG. 6.

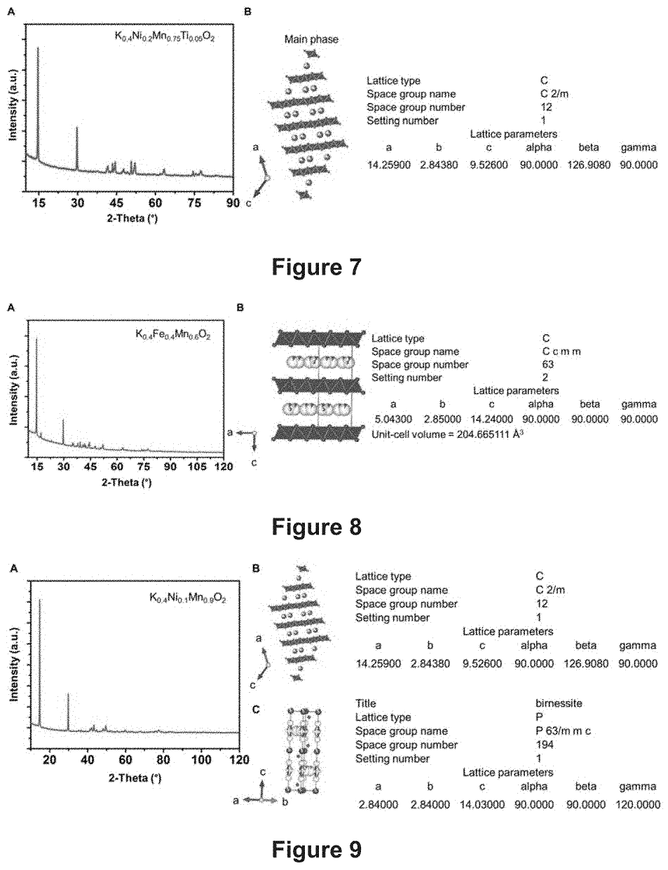

According to another alternative, the layered potassium metal oxide in crystalline form is of formula K_{0.4}Ni_{0.2}Mn_{0.75}Ti_{0.05}O₂ and has an XRD pattern substantially as shown in FIG. 7.

According to another alternative, the layered potassium metal oxide in crystalline form is of formula K_{0.4}Fe_{0.4}Mn_{0.6}O₂ and has an XRD pattern substantially as shown in FIG. 8.

According to another alternative, the layered potassium metal oxide in crystalline form is of formula K_{0.4}Ni_{0.1}Mn_{0.9}O₂ and has an XRD pattern substantially as shown in FIG. 9.

According to another alternative, the layered potassium metal oxide in crystalline form is of formula K_{0.4}MnO₂ and has an XRD pattern substantially as shown in FIG. 10.

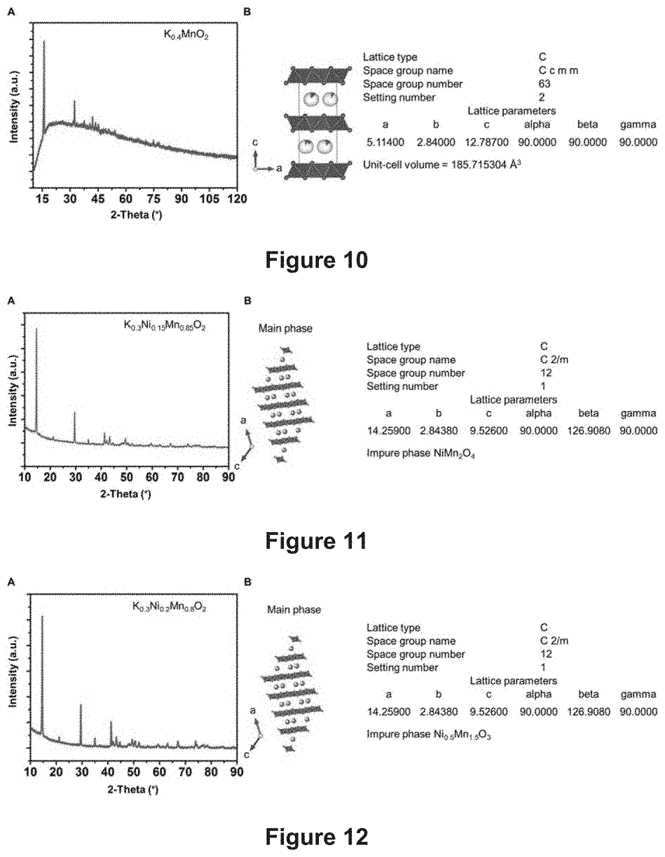

According to another alternative, the layered potassium metal oxide in crystalline form is of formula K_{0.3}Ni_{0.15}Mn_{0.85}O₂ and has an XRD pattern substantially as shown in FIG. 11.

According to another alternative, the layered potassium metal oxide in crystalline form is of formula K_{0.3}Ni_{0.2}Mn_{0.8}O₂ and has an XRD pattern substantially as shown in FIG. 12.

According to another alternative, the layered potassium metal oxide in crystalline form is of formula K_{0.3}MnO₂ and has an XRD pattern substantially as shown in FIG. 13.

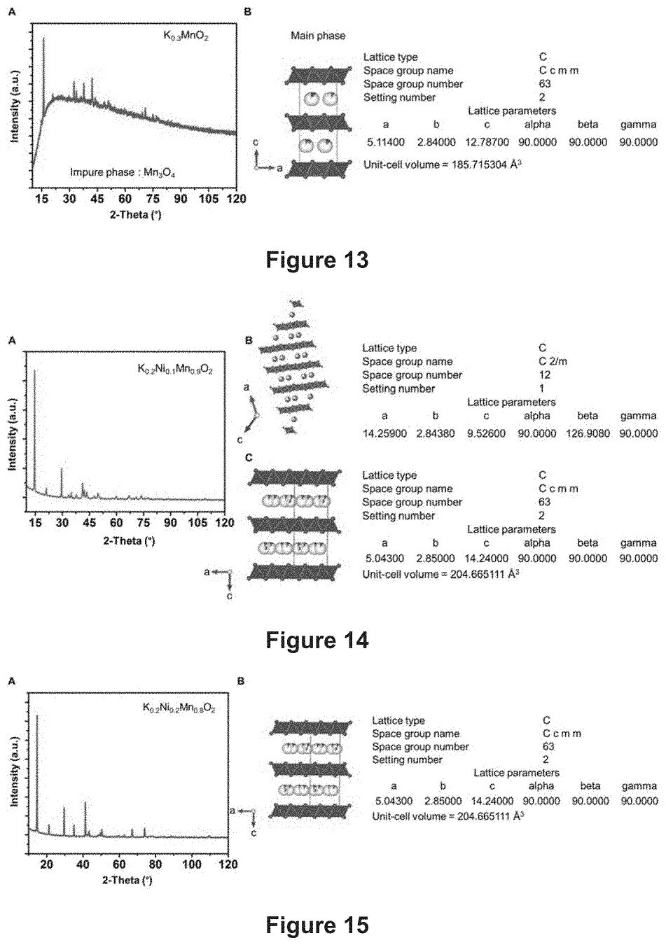

According to another alternative, the layered potassium metal oxide in crystalline form is of formula K_{0.2}Ni_{0.1}Mn_{0.9}O₂ and has an XRD pattern substantially as shown in FIG. 14.

According to another alternative, the layered potassium metal oxide in crystalline form is of formula K_{0.2}Ni_{0.2}Mn_{0.8}O₂ and has an XRD pattern substantially as shown in FIG. 15.

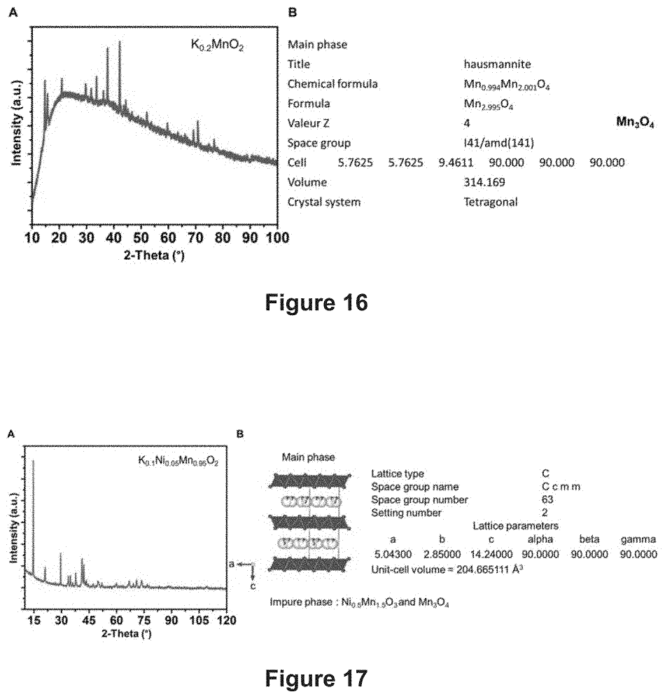

According to another alternative, the layered potassium metal oxide in crystalline form is of formula K_{0.2}MnO₂ and has an XRD pattern substantially as shown in FIG. 16.

According to another alternative, the layered potassium metal oxide in crystalline form is of formula K_{0.1}Ni_{0.05}Mn_{0.95}O₂ and has an XRD pattern substantially as shown in FIG. 17.

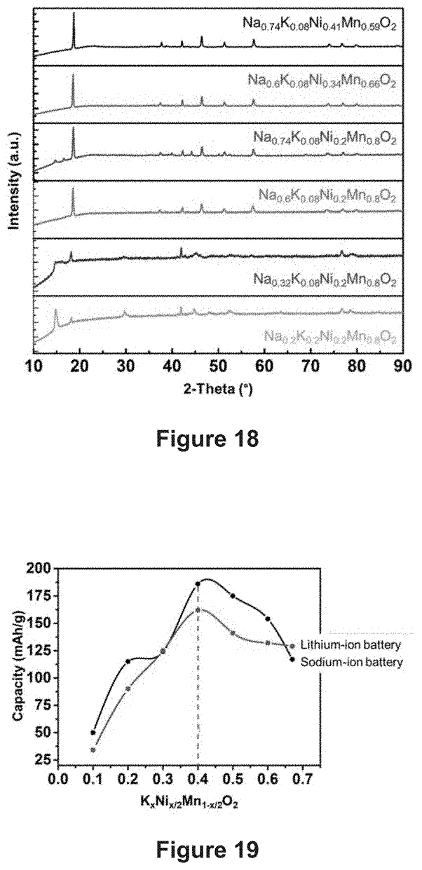

According to another alternative, the layered potassium metal oxide in crystalline form is of formula Na_{0.74}K_{0.08}Ni_{0.41}Mn_{0.59}O₂, Na_{0.6}K_{0.08}Ni_{0.34}Mn_{0.66}O₂, Na_{0.74}Ni_{0.2}Mn_{0.8}O₂, Na_{0.6}K_{0.08}Ni_{0.2}Mn_{0.8}O₂, Na_{0.32}K_{0.08}Ni_{0.2}Mn_{0.8}O₂, or Na_{0.2}K_{0.2}Ni_{0.2}Mn_{0.8}O₂, and has an XRD pattern substantially as shown in FIG. 18.

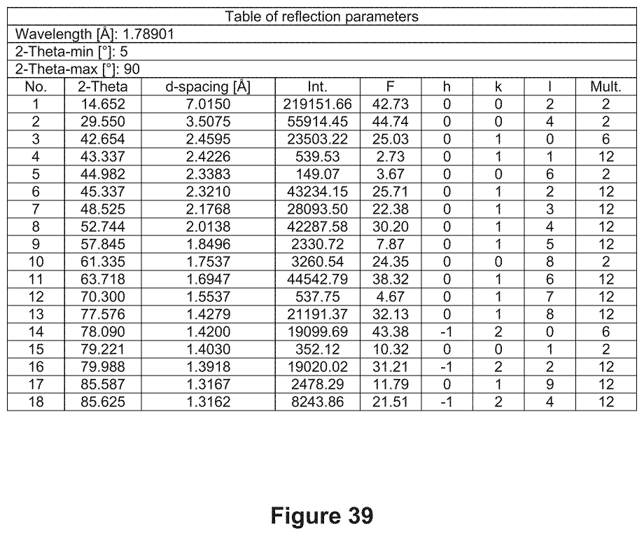

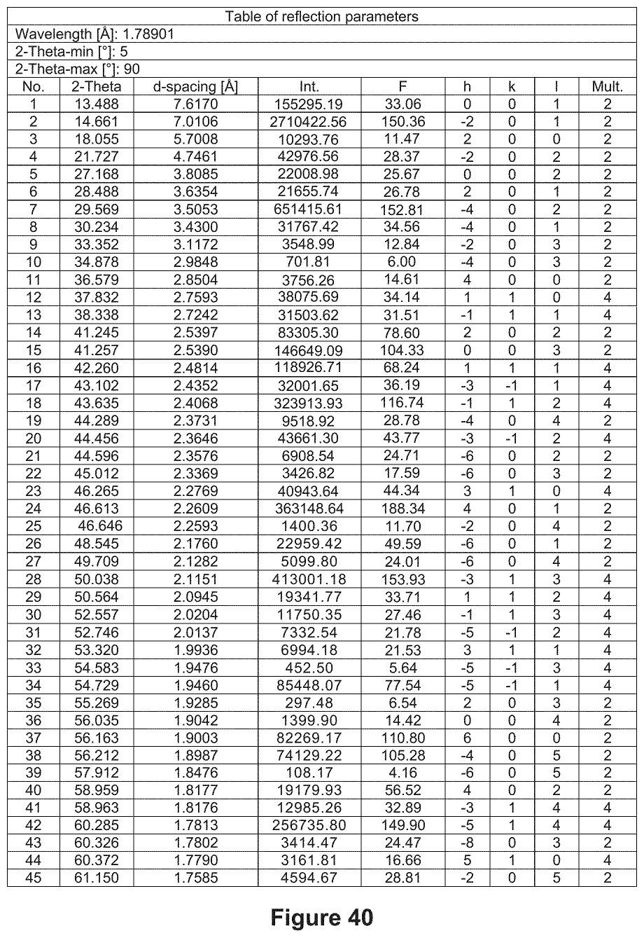

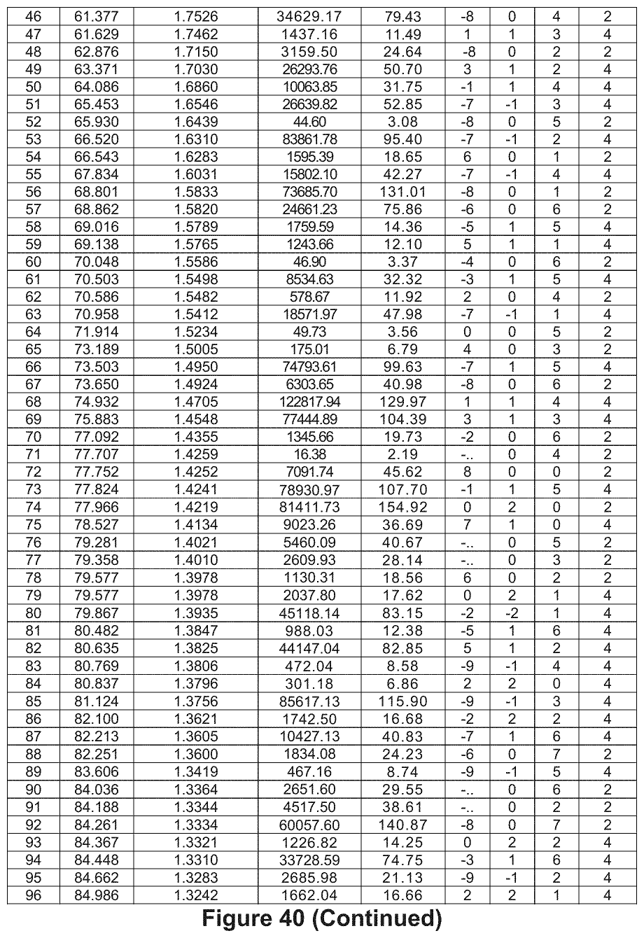

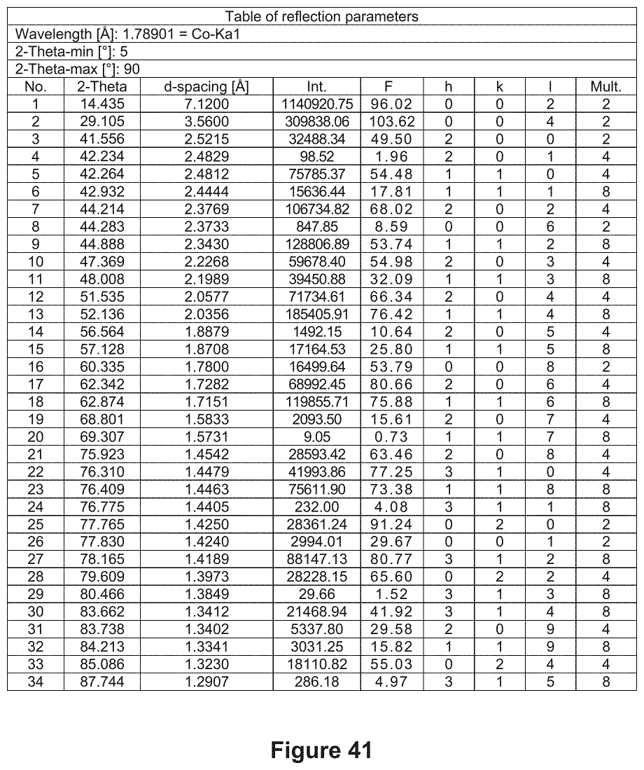

According to at least one example, the layered potassium metal oxide in crystalline form of formula KₓMO₂ has XRD 2⊖ (°) reflections substantially as shown in FIG. 39. According to one alternative, the layered potassium metal oxide in crystalline form of formula KₓMO₂ has XRD 2⊖ (°) reflections substantially as shown in FIG. 40. According to another alternative, the layered potassium metal oxide in crystalline form of formula KₓMO₂ has XRD 2⊖ (°) reflections substantially as shown in FIG. 41.

According to another embodiment of interest, the layered potassium metal oxide in crystalline form is of formula K_{0.4}Ni_{0.2}Mn_{0.8}O₂ and has an XRD pattern substantially as shown in FIG. 4, or has XRD 2⊖ reflections (°) substantially as shown in FIG. 40.

According to another embodiment of interest, the layered potassium metal oxide in crystalline form is of formula K_{0.4}Ni_{0.2}Mn_{0.6}Ti_{0.2}O₂, and has an XRD pattern substantially as shown in FIG. 5.

According to another embodiment of interest, the layered potassium metal oxide in crystalline form is of formula K_{0.4}Ni_{0.2}Mn_{0.7}Ti_{0.1}O₂, and has an XRD pattern substantially as shown in FIG. 6, or has XRD 2⊖ reflections (°) substantially as shown in FIG. 40.

According to another embodiment of interest, the layered potassium metal oxide in crystalline form is of formula K_{0.4}Ni_{0.2}Mn_{0.75}Ti_{0.05}O₂, and has an XRD pattern substantially as shown in FIG. 7 or has XRD 2⊖ reflections (°) substantially as shown in FIG. 40.

According to another embodiment of interest, the layered potassium metal oxide in crystalline form is of formula K_{0.4}Fe_{0.4}Mn_{0.6}O₂, and has an XRD pattern substantially as shown in FIG. 8, or has XRD 2⊖ reflections (°) substantially as shown in FIG. 41.

According to another embodiment of interest, the layered potassium metal oxide in crystalline form is of formula K_{0.4}Ni_{0.1}Mn_{0.9}O₂, and has an XRD pattern substantially as shown in FIG. 9, or has XRD 2⊖ reflections (°) substantially as shown in FIG. 39 and/or FIG. 40.

According to another embodiment of interest, the layered potassium metal oxide in crystalline form is of formula K_{0.3}Ni_{0.15}Mn_{0.85}O₂, and has an XRD pattern substantially as shown in FIG. 11, or has XRD 2⊖ reflections (°) substantially as shown in FIG. 40.

According to another embodiment of interest, the layered potassium metal oxide in crystalline form is of formula K_{0.3}Ni_{0.2}Mn_{0.8}O₂, and has an XRD pattern substantially as shown in FIG. 12, or has XRD 2⊖ reflections (°) substantially as shown in FIG. 40.

According to another embodiment of interest, the layered potassium metal oxide in crystalline form is of formula K_{0.2}Ni_{0.1}Mn_{0.9}O₂, and has an XRD pattern substantially as shown in FIG. 14, or has XRD 2⊖ reflections (°) substantially as shown in FIG. 40 and/or FIG. 41.

According to another embodiment of interest, the layered potassium metal oxide in crystalline form is of formula K_{0.2}Ni_{0.2}Mn_{0.8}O₂, and has an XRD pattern substantially as shown in FIG. 15, or has XRD 2⊖ reflections (°) substantially as shown in FIG. 41.

According to another embodiment of interest, the layered potassium metal oxide in crystalline form is of formula K_{0.1}Ni_{0.05}Mn_{0.95}O₂, and has an XRD pattern substantially as shown in FIG. 17, or has XRD 2⊖ reflections (°) substantially as shown in FIG. 41.

### EXAMPLES

The following examples are for illustrative purposes and should not be interpreted as further limiting the scope of the invention as contemplated. These examples will be better understood by referring to the accompanying Figures.

### Example 1: Synthesis of Electrochemically Active Materials

### a) Solid-State Synthesis

Layered potassium metal oxides of formulae K_{0.67}Ni_{0.33}Mn_{0.67}O₂, K_{0.6}Ni_{0.3}Mn_{0.7}O₂, K_{0.5}Ni_{0.25}Mn_{0.75}O₂, K_{0.4}Ni_{0.2}Mn_{0.8}O₂, K_{0.4}Ni_{0.2}Mn_{0.6}Ti_{0.2}O₂, K_{0.4}Ni_{0.2}Mn_{0.7}Ti_{0.1}O₂, K_{0.4}Ni_{0.2}Mn_{0.75}Ti_{0.05}O₂, K_{0.4}Fe_{0.4}Mn_{0.6}O₂, Mn_{0.9}O₂, K_{0.4}MnO₂, K_{0.3}Ni_{0.15}Mn_{0.85}O₂, K_{0.3}Ni_{0.2}Mn_{0.8}O₂, K_{0.3}MnO₂, K_{0.2}Ni_{0.1}Mn_{0.9}O₂, K_{0.2}Ni_{0.2}Mn_{0.8}O₂, K_{0.2}MnO₂, K_{0.1}Ni_{0.05}Mn_{0.95}O₂, K_{0.1}Ni_{0.1}Mn_{0.9}O₂, Na_{0.74}K_{0.08}Ni_{0.41}Mn_{0.59}O₂, Na_{0.6}K_{0.08}Ni_{0.34}Mn_{0.66}O₂, Na_{0.74}K_{0.08}Ni_{0.2}Mn_{0.8}O₂, Na_{0.6}K_{0.08}Ni_{0.2}Mn_{0.8}O₂, Na_{0.32}K_{0.08}Ni_{0.2}Mn_{0.8}O₂, and Na_{0.2}K_{0.2}Ni_{0.2}Mn_{0.8}O₂ were prepared using solid-state reaction techniques. The respective precursors (K₂CO₃/KOH, and metal oxides such as Na₂CO₃, Mn₂O₃, CO₂₃, CuO, ZrO₂, NiO, Fe₂O₃, and TiO₂) were weighed to obtain the desired stoichiometries. The samples were prepared by grinding and mixing the precursor powders. The ground and mixed precursor powders were then placed in a furnace and heated to a temperature between 600° C. and 1000° C. under an air or oxygen atmosphere for 5 to 24 hours. For example, at a temperature between 800° C. and 1000° C. and for 6 to 8 hours.

### b) Wet Chemical Synthesis

Alternatively, the layered potassium metal oxides as defined herein may be prepared using wet chemical synthesis techniques. For example, the layered potassium metal oxides as defined herein may be prepared by a sol-gel process, for example, by a sol-gel (333SG) process similar to the one described by Hashem et al. (Hashem, Ahmed M., et al. Research on Engineering Structures and Materials 1.2 (2015): 81-97). For example, using this sol-gel process, sol-gel powders (333SG) are synthesized using citric acid as a chelating agent. The respective precursors (metal acetates, where the metal is Na, Mn, Ti, K, Fe or Ni) are weighed to obtain the desired stoichiometry and dissolved in distilled water. The solution is added dropwise to a continuously stirred aqueous citric acid solution of about 1 mol/L. The pH is adjusted to a value between about 7.0 and about 8.0 with ammonium hydroxide. The solution is then heated to a temperature between about 70° C. and about 80° C., while stirring to evaporate the solvents, until a clear sol-gel precursor is obtained. The resulting sol-gel precursor is calcined in an oven at a temperature of about 450° C. for about 8 hours in an air or oxygen atmosphere to remove the organic content. Finally, the resulting powder is ground in a mortar and calcined at a temperature of about 900° C. for about 12 hours.

### Example 2: Characterization of Electrochemically Active Materials

### a) Powder X-Ray Diffraction (XRD)

The atomic and molecular structure of the electrochemically active materials was studied by X-ray diffraction performed on the layered potassium metal oxide powders prepared in Example 1(a). FIGS. 1 to 17 show in (A) the X-ray diffraction patterns for the layered potassium metal oxide powders of formulae K_{0.67}Ni_{0.33}Mn_{0.67}O₂, K_{0.6}Ni_{0.3}Mn_{0.7}O₂, K_{0.5}Ni_{0.25}Mn_{0.75}O₂, K_{0.4}Ni_{0.2}Mn_{0.8}O₂, K_{0.4}Ni_{0.2}Mn_{0.6}Ti_{0.2}O₂, K_{0.4}Ni_{0.2}Mn_{0.7}Ti_{0.1}O₂, K_{0.4}Ni_{0.2}Mn_{0.75}Ti_{0.05}O₂, K_{0.4}Fe_{0.4}Mn_{0.6}O₂, K_{0.4}Ni_{0.1}Mn_{0.9}O₂, K_{0.4}Mn_{0.2}, K_{0.3}Ni_{0.15}Mn_{0.85}O₂, K_{0.3}Ni_{0.2}Mn_{0.8}O₂, K_{0.3}MnO₂, K_{0.2}Ni_{0.1}Mn_{0.9}O₂, K_{0.2}Ni_{0.2}Mn_{0.8}O₂, K_{0.2}MnO₂, and K_{0.1}Ni_{0.05}Mn_{0.95}O₂. FIG. 18 shows the X-ray diffraction patterns for the layered potassium metal oxide powders of formulae Na_{0.74}K_{0.08}Ni_{0.41}Mn_{0.59}O₂, Na_{0.6}K_{0.08}Ni_{0.34}Mn_{0.66}O₂, Na_{0.74}K_{0.08}Ni_{0.2}Mn_{0.8}O₂, Na_{0.6}K_{0.08}Ni_{0.2}Mn_{0.8}O₂, Na_{0.32}K_{0.08}Ni_{0.2}Mn_{0.8}O₂, and Na_{0.2}K_{0.2}Ni_{0.2}Mn_{0.8}O₂.

The X-ray spectra were obtained using a Rigaku Smartlab™ X-ray diffractometer equipped with a cobalt X-ray source emitting X-rays with a wavelength, λ=1.78901 Å.

### b) Crystal Structure Characteristics

Data processing and crystal structure characterization were performed by indexing and comparing the XRD spectra with database patterns to confirm the crystal structure of the layered potassium metal oxides.

FIGS. 1 to 3(B) and FIG. 9(C) respectively show an illustration of the crystal structure of the layered potassium metal oxides of formulae K_{0.67}Ni_{0.33}Mn_{0.67}O₂, K_{0.6}Ni_{0.3}Mn_{0.7}O₂, K_{0.5}Ni_{0.25}Mn_{0.75}O₂, and K_{0.4}Ni_{0.1}Mn_{0.9}O₂ and having the crystal structure characteristics presented in Table 1.

TABLE 1
Crystal structure characteristics of layered potassium
metal oxides of formulae K_{0.67}Ni_{0.33}Mn_{0.67}O₂, K_{0.6}Ni_{0.3}Mn_{0.7}O₂,
K_{0.5}Ni_{0.25}Mn_{0.75}O₂ and K_{0.4}Ni_{0.1}Mn_{0.9}O₂

| Lattice type | P |
|---|---|
| Space group name | P63/m m c |
| Space group number | 194 |
| Setting number | 1 |

Lattice parameters

| a (Å) | b (Å) | c (Å) | alpha (°) | beta (°) | gamma (°) |
|---|---|---|---|---|---|
| 2.84000 | 2.84000 | 14.03000 | 90.0000 | 90.0000 | 120.0000 |

The reflection parameters of the layered potassium metal oxides having the crystal structure characteristics presented in Table 1 are presented in FIG. 39.

FIGS. 4, 6, 7, 9, 11, 12 and 14(B) respectively show an illustration of the crystal structure of the layered potassium metal oxides of formulae K_{0.4}Ni_{0.2}Mn_{0.8}O₂, K_{0.4}Ni_{0.2}Mn_{0.7}Ti_{0.1}O₂, K_{0.4}Ni_{0.2}Mn_{0.75}Ti_{0.05}O₂, K_{0.4}Ni_{0.1}Mn_{0.9}O₂, K_{0.3}Ni_{0.15}Mn_{0.85}O₂, K_{0.3}Ni_{0.2}Mn_{0.8}O₂ and K_{0.2}Ni_{0.1}Mn_{0.9}O₂ and having the crystal structure characteristics presented in Table 2.

TABLE 2
Crystal structure characteristics of
layered potassium metal oxides of formulae K_{0.4}Ni_{0.2}Mn_{0.8}O₂,
K_{0.4}Ni_{0.2}Mn_{0.7}Ti_{0.1}O₂, K_{0.4}Ni_{0.2}Mn_{0.75}Ti_{0.05}O₂, K_{0.4}Ni_{0.1}Mn_{0.9}O₂,
K_{0.3}Ni_{0.15}Mn_{0.85}O₂, K_{0.3}Ni_{0.2}Mn_{0.8}O₂ and K_{0.2}Ni_{0.1}Mn_{0.9}O₂

| Lattice type | C |
|---|---|
| Space group name | C2/m |
| Space group number | 12 |
| Setting number | 1 |

Lattice parameters

| a (Å) | b (Å) | c (Å) | alpha (°) | beta (°) | gamma (°) |
|---|---|---|---|---|---|
| 14.25900 | 2.84380 | 9.52600 | 90.0000 | 126.9080 | 90.0000 |

The reflection parameters of the layered potassium metal oxides having the crystal structure characteristics presented in Table 2 are presented in FIG. 40.

FIGS. 8(B), 14(C), 15(B) and 17(B) respectively show an illustration of the crystal structure of the layered potassium metal oxides of formulae K_{0.4}Fe_{0.4}Mn_{0.6}O₂, K_{0.2}Ni_{0.1}Mn_{0.9}O₂, K_{0.2}Ni_{0.2}Mn_{0.8}O₂, and K_{0.1}Ni_{0.05}Mn_{0.95}O₂ and having the crystal structure characteristics presented in Table 3.

TABLE 3
Crystal structure characteristics of layered potassium
metal oxides of formulae K_{0.4}Fe_{0.4}Mn_{0.6}O₂,
K_{0.2}Ni_{0.1}Mn_{0.9}O₂, K_{0.2}Ni_{0.2}Mn_{0.8}O₂ and K_{0.1}Ni_{0.05}Mn_{0.95}O₂

| Lattice type | C |
|---|---|
| Space group name | C c m m |
| Space group number | 63 |
| Setting number | 2 |

Lattice parameters

| a (Å) | b (Å) | c (Å) | alpha (°) | beta (°) | gamma (°) |
|---|---|---|---|---|---|
| 5.04300 | 2.85000 | 14.24000 | 90.0000 | 90.0000 | 90.0000 |

| | |
|---|---|
| Unit-cell volume | 204.665111 Å³ |

The reflection parameters of the layered potassium metal oxides having the crystal structure characteristics presented in Table 3 are presented in FIG. 41.

FIGS. 10 and 13 respectively show in (B) an illustration of the crystal structure of the layered potassium metal oxides of formulae K_{0.4}MnO₂ and K_{0.3}MnO₂ and having the crystal structure characteristics presented in Table 4.

TABLE 4
Crystal structure characteristics of layered potassium
metal oxides of formulae K_{0.4}MnO₂ or K_{0.3}MnO₂

| Lattice type | C |
|---|---|
| Space group name | C c m m |
| Space group number | 63 |
| Setting number | 2 |

Lattice parameters

| a (Å) | b (Å) | c (Å) | alpha (°) | beta (°) | gamma (°) |
|---|---|---|---|---|---|
| 5.11400 | 2.84000 | 12.78700 | 90.0000 | 90.0000 | 90.0000 |

| | |
|---|---|
| Unit-cell volume | 185.715304 Å³ |

FIG. 16 shows in (B) the crystal structure characteristics of a layered potassium metal oxide of formula K_{0.2}MnO₂. The main phase consists of a tetragonal manganese oxide Mn₃O₄.

As mentioned above, two structures are proposed for the layered potassium metal oxides of formulae K_{0.4}Ni_{0.1}Mn_{0.9}O₂ (FIG. 9, Tables 1 and 2) and K_{0.2}Ni_{0.1}Mn_{0.9})₂ (FIG. 14, Tables 2 and 3). Indeed, according to the X-ray diffraction patterns, these two structures may be possible.

### Example 3: Electrochemical Properties

The electrochemical properties of the electrochemically active materials as prepared in Example 1(a) were studied. The electrochemical cells were assembled according to the electrochemical cell configurations shown in Table 5.

### a) Electrochemical Cell Configurations

TABLE 5
Electrochemical cell configurations

| | Electrochemically active | Electrochemically active |
|---|---|---|
| | material of the | material of the |
| Cell | positive electrode | negative electrode |
| Cell 1 | K_{0.67}Ni_{0.33}Mn_{0.67}O₂ | Lithium metal |
| Cell 2 | K_{0.67}Ni_{0.33}Mn_{0.67}O₂ | Sodium metal |
| Cell 3 | K_{0.6}Ni_{0.3}Mn_{0.7}O₂ | Lithium metal |
| Cell 4 | K_{0.6}Ni_{0.3}Mn_{0.7}O₂ | Sodium metal |
| Cell 5 | K_{0.5}Ni_{0.25}Mn_{0.75}O₂ | Lithium metal |
| Cell 6 | K_{0.5}Ni_{0.25}Mn_{0.75}O₂ | Sodium metal |
| Cell 7 | K_{0.4}Ni_{0.2}Mn_{0.8}O₂ | Lithium metal |
| Cell 8 | K_{0.4}Ni_{0.2}Mn_{0.8}O₂ | Sodium metal |
| Cell 9 | K_{0.4}Ni_{0.2}Mn_{0.6}Ti_{0.2}O₂ | Lithium metal |
| Cell 10 | K_{0.4}Ni_{0.2}Mn_{0.6}Ti_{0.2}O₂ | Sodium metal |
| Cell 11 | K_{0.4}Ni_{0.2}Mn_{0.7}Ti_{0.1}O₂ | Lithium metal |
| Cell 12 | K_{0.4}Ni_{0.2}Mn_{0.7}Ti_{0.1}O₂ | Sodium metal |
| Cell 13 | K_{0.4}Ni_{0.2}Mn_{0.75}Ti_{0.05}O₂ | Lithium metal |
| Cell 14 | K_{0.4}Ni_{0.2}Mn_{0.75}Ti_{0.05}O₂ | Sodium metal |
| Cell 15 | K_{0.4}Fe_{0.4}Mn_{0.6}O₂ | Lithium metal |
| Cell 16 | K_{0.4}Fe_{0.4}Mn_{0.6}O₂ | Sodium metal |
| Cell 17 | K_{0.4}Ni_{0.1}Mn_{0.9}O₂ | Lithium metal |
| Cell 18 | K_{0.4}Ni_{0.1}Mn_{0.9}O₂ | Sodium metal |
| Cell 19 | K_{0.3}Ni_{0.15}Mn_{0.85}O₂ | Lithium metal |
| Cell 20 | K_{0.3}Ni_{0.15}Mn_{0.85}O₂ | Sodium metal |
| Cell 21 | K_{0.3}Ni_{0.2}Mn_{0.8}O₂ | Lithium metal |
| Cell 22 | K_{0.3}Ni_{0.2}Mn_{0.8}O₂ | Sodium metal |
| Cell 23 | K_{0.2}Ni_{0.1}Mn_{0.9}O₂ | Lithium metal |
| Cell 24 | K_{0.2}Ni_{0.1}Mn_{0.9}O₂ | Sodium metal |
| Cell 25 | K_{0.2}Ni_{0.2}Mn_{0.8}O₂ | Lithium metal |
| Cell 26 | K_{0.2}Ni_{0.2}Mn_{0.8}O₂ | Sodium metal |
| Cell 27 | K_{0.2}MnO₂ | Lithium metal |
| Cell 28 | K_{0.2}MnO₂ | Sodium metal |
| Cell 29 | K_{0.1}Ni_{0.05}Mn_{0.95}O₂ | Lithium metal |
| Cell 30 | K_{0.1}Ni_{0.05}Mn_{0.95}O₂ | Sodium metal |
| Cell 31 | K_{0.1}Ni_{0.1}Mn_{0.9}O₂ | Lithium metal |
| Cell 32 | K_{0.1}Ni_{0.1}Mn_{0.9}O₂ | Sodium metal |
| Cell 33 | Na_{0.74}K_{0.08}Ni_{0.41}Mn_{0.59}O₂ | Sodium metal |
| Cell 34 | Na_{0.6}K_{0.08}Ni_{0.34}Mn_{0.66}O₂ | Sodium metal |
| Cell 35 | Na_{0.6}K_{0.08}Ni_{0.2}Mn_{0.8}O₂ | Sodium metal |

All electrochemical cells were assembled in 2032 type coin cell casings with the components listed above and the negative electrodes including lithium or sodium metal films on aluminum current collectors. The electrochemical cells included an electrode material comprising about 80 wt. % of electrochemically active material, about 10 wt. % of binder (PVDF), and about 10 wt. % of electronically conductive material (Ketjen™ black, Super P™, or VGCF). All electrochemical cells comprising liquid electrolytes were assembled with Celgard™ separators.

The separators of the electrochemical cells comprising negative electrodes including a lithium metal film were impregnated with a 1 M LiPF₆ solution in an EC/DMC mixture ([4:6] by volume) as a liquid electrolyte and about 2 vol. % of VC.

The separators of the electrochemical cells comprising negative electrodes including a sodium metal film were impregnated with a 1 M NaPF₆ solution in EC/DEC ([3:7] by volume) or EC/DMC ([4:6] by volume) as a liquid electrolyte.

### b) Electrochemical Behavior of Layered Potassium Metal Oxides

This example illustrates the electrochemical behavior of electrochemical cells as described in Example 3(a).

FIG. 19 shows a graph of the capacity (mAh·g⁻¹) versus x for a layered potassium metal oxide of formula KₓNi_{0.5x}Mn_{1-0.5x}O₂ recorded for x between 0.1 and 0.7. The results are presented for a lithium-ion battery (red line) and for a sodium-ion battery (black line). As shown in FIG. 19, x may preferably be about 0.4.

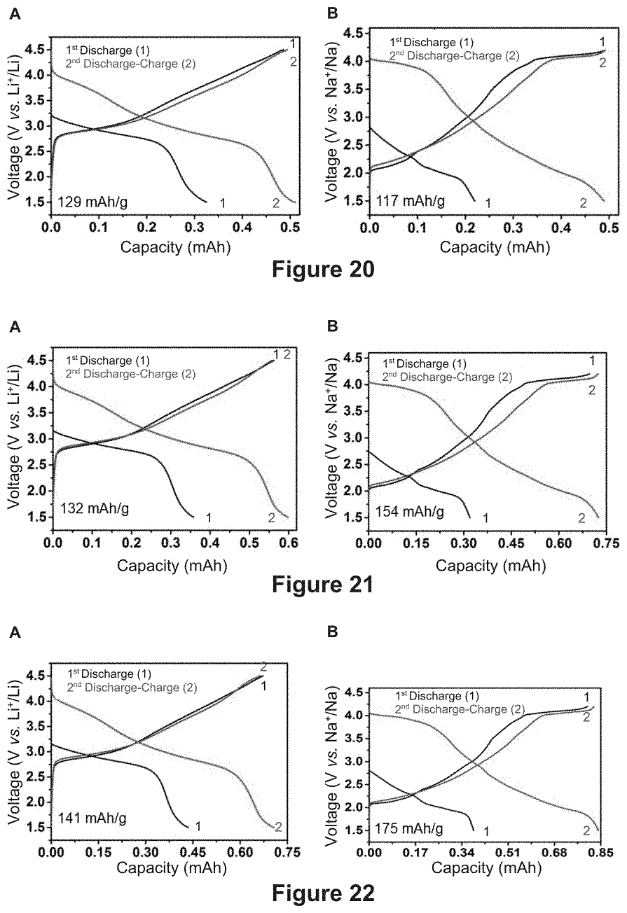

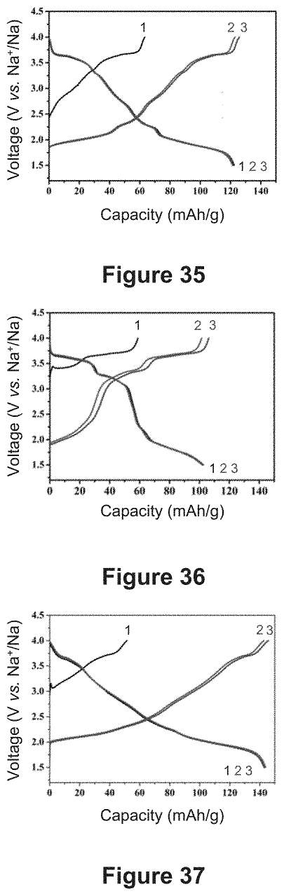

FIGS. 20 to 37 show the charge and discharge profiles for Cells 1 to 28 and 33 to 35. The charge and discharge were performed at 0.1 C between 1.5 V and 4.5 V vs. Li⁺/Li for all electrochemical cells including a lithium metal film as a negative electrode and at 0.1 C between 1.5 V and 4.2 V vs. Na⁺/Na for all electrochemical cells including a sodium metal film as a negative electrode. The charge and discharge were performed at a temperature of 25° C. starting with a discharge. Results are presented for a first (black line, 1), a second (red line, 2), and eventually a third (blue line, 3) discharge and charge cycle. The capacity delivered by each of the electrochemical cells is presented in Table 6.

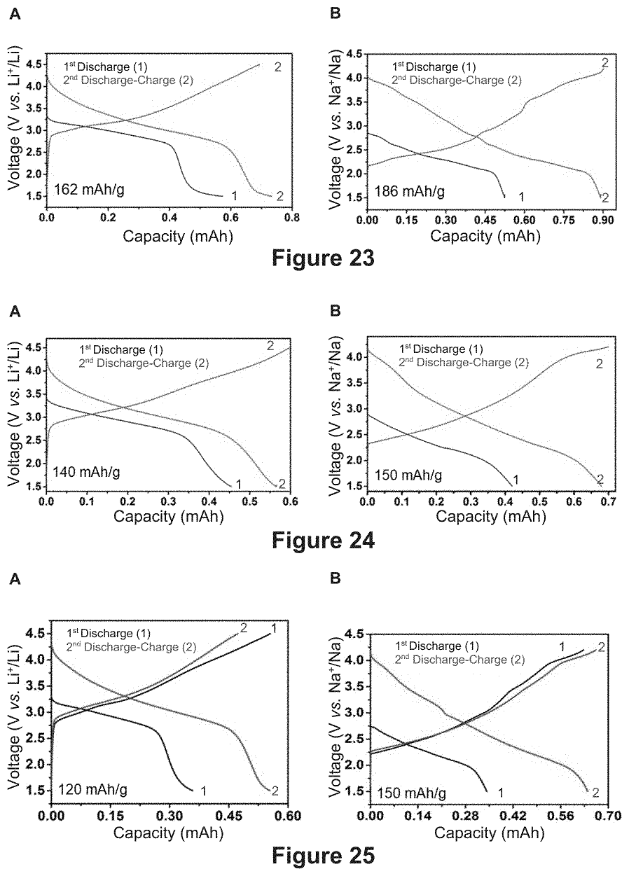

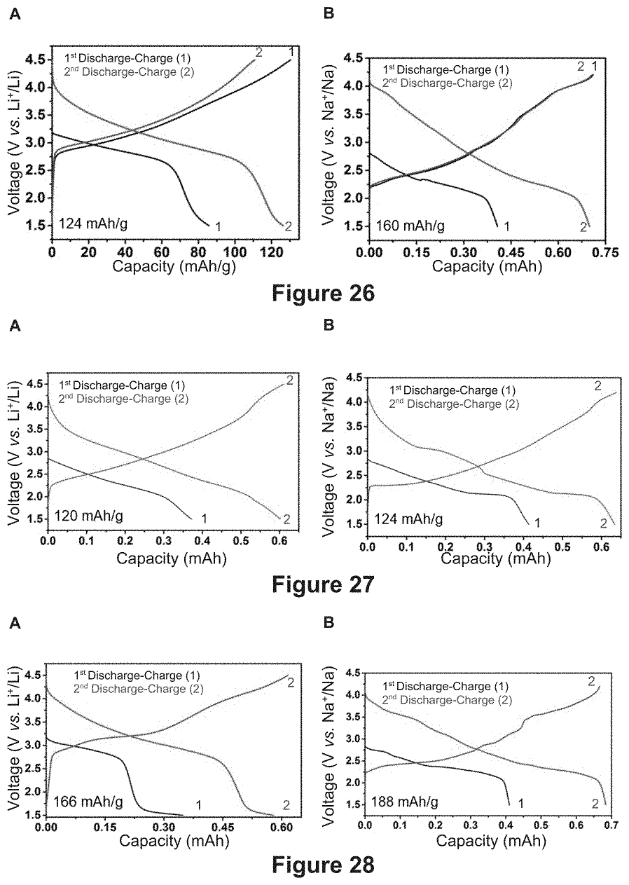

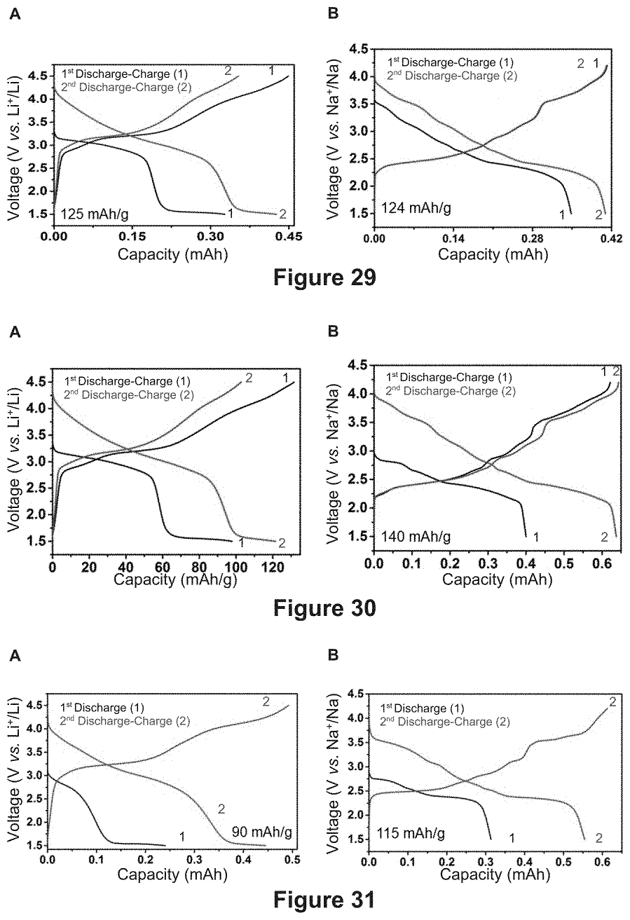

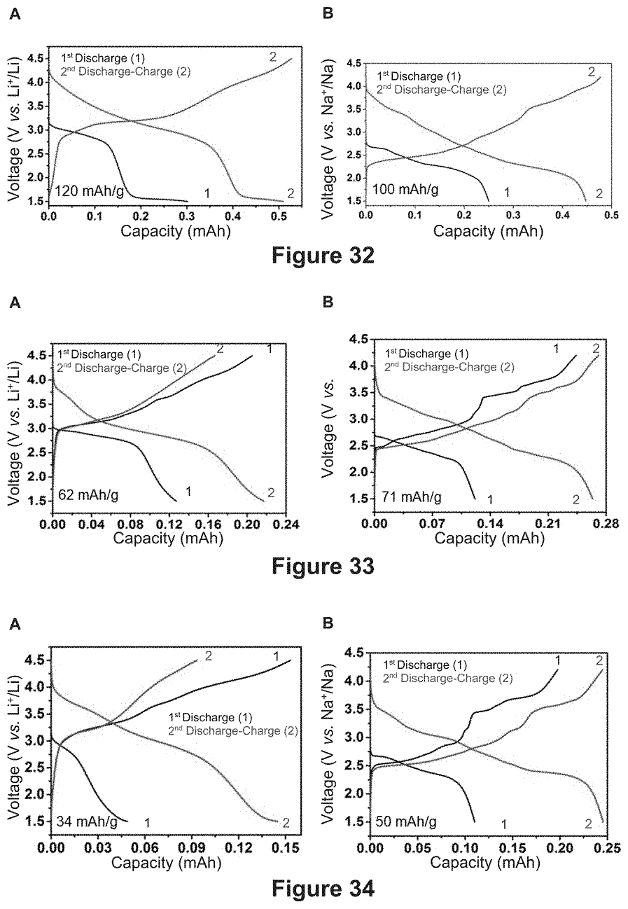

TABLE 6
Capacity delivered by the cells of Table 5

| | Lithium- | Capacity | Sodium- | Capacity |
|---|---|---|---|---|
| FIG. | ion cell | (mAh · g⁻¹) | ion cell | (mAh · g⁻¹) |
| FIG. 20 | Cell 1 | ~129 | Cell 2 | ~117 |
| FIG. 21 | Cell 3 | ~132 | Cell 4 | ~154 |
| FIG. 22 | Cell 5 | ~141 | Cell 6 | ~175 |
| FIG. 23 | Cell 7 | ~162 | Cell 8 | ~186 |
| FIG. 24 | Cell 9 | ~140 | Cell 10 | ~150 |
| FIG. 25 | Cell 11 | ~120 | Cell 12 | ~150 |
| FIG. 26 | Cell 13 | ~124 | Cell 14 | ~160 |
| FIG. 27 | Cell 15 | ~120 | Cell 16 | ~124 |
| FIG. 28 | Cell 17 | ~166 | Cell 18 | ~188 |
| FIG. 29 | Cell 19 | ~125 | Cell 20 | ~124 |
| FIG. 30 | Cell 21 | ~124 | Cell 22 | ~140 |
| FIG. 31 | Cell 23 | ~90 | Cell 24 | ~115 |
| FIG. 32 | Cell 25 | ~120 | Cell 26 | ~100 |
| FIG. 33 | Cell 27 | ~62 | Cell 28 | ~71 |
| FIG. 34 | Cell 29 | ~34 | Cell 30 | ~50 |

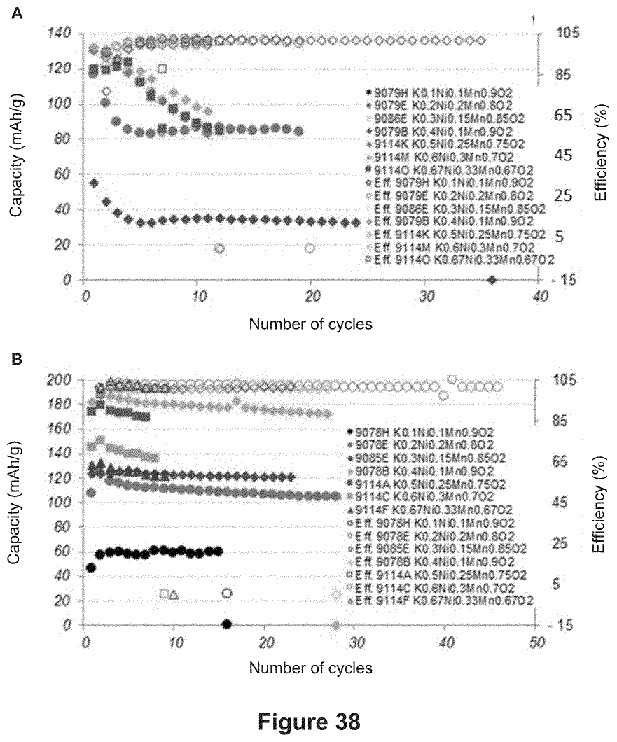

FIG. 38 shows a graph representing capacity (mAh g⁻¹) and efficiency (%) as a function of the number of cycles in (A) for Cells 1, 3, 5, 17, 19, 25, and 31; and in (B) for Cells 2, 4, 6, 18, 26, and 32. The long cycling experiments were performed at a constant charge and discharge current of C/10 and a temperature of about 25° C. The results shown in FIG. 38(A) were recorded vs. Li⁺/Li for about 45 cycles and in (B) vs. Na⁺/Na for about 35 cycles.

Numerous modifications could be made to any of the embodiments described above without departing from the scope of the present invention as contemplated. The references, patents or scientific literature documents referred to in the present application are incorporated herein by reference in their entirety for all purposes.

1. An electrode material comprising an electrochemically active material, said electrochemically active material comprising a layered potassium metal oxide of formula KₓMO₂, wherein x is a number such that 0<x≤0.7, and M is selected from Co, Mn, Fe, Ni, Ti, Cr, V, Cu, Zr, Sb, and a combination of at least two thereof.

2. The electrode material of claim 1, wherein the electrochemically active material comprises a layered potassium metal oxide of formula KₓM_{y}Mn_{1-y}O₂, wherein x is as defined in claim 1, y is a number such that 0≤y≤1.0, and M is selected from Co, Fe, Ni, Ti, Cr, V, Cu, Zr, Sb, and a combination of at least two thereof.

3. The electrode material of claim 1 or 2, wherein the layered potassium metal oxide is of formula KₓFe_{y}Mn_{1-y}O₂, wherein x is as defined in claim 1, and y is a number such that 0≤y≤1.0.

4. The electrode material of claim 1 or 2, wherein the layered potassium metal oxide is of formula KₓMnO₂, wherein x is as defined in claim 1.

5. The electrode material of claim 1 or 2, wherein the layered potassium metal oxide is of formula KₓNiMnO₂, wherein x is as defined in claim 1.

6. The electrode material of claim 1 or 2, wherein the layered potassium metal oxide is of formula KₓNiMnTiO₂, wherein x is as defined in claim 1.

7. The electrode material of claim 1 or 2, wherein the layered potassium metal oxide is of formula KₓFeMnO₂, wherein x is as defined in claim 1.

8. The electrode material of claim 1 or 2, wherein the layered potassium metal oxide is of formula KₓNi_{0.5x}Mn_{1-0.5x}O₂, wherein x is as defined in claim 1.

9. The electrode material of claim 1 or 2, wherein the layered potassium metal oxide is of formula KₓNi_{0.5x}Mn_{1-0.5x-y}M_{y}O₂, wherein x is as defined in claim 1, y is a number such that 0≤y≤(1.0-0.5x), and M is selected from Co, Fe, Ti, Cr, V, Cu, Zr, Sb, and a combination of at least two thereof.

10. The electrode material of claim 9, wherein the layered potassium metal oxide is of formula KₓNi_{0.5x}Mn_{1-0.5x}Ti_{y}O₂, wherein x is as defined in claim 1, and y is as defined in claim 9.

11. The electrode material of claim 9 or 10, wherein the layered potassium metal oxide is of formula K_{0.4}Ni_{0.2}Mn_{0.8-y}Ti_{y}O₂, wherein y is a number such that 0≤y≤0.8.

12. The electrode material of any one of claims 1 to 11, wherein the layered potassium metal oxide is selected from the group consisting of K_{0.67}Ni_{0.33}Mn_{0.67}O₂, K_{0.6}Ni_{0.3}Mn_{0.7}O₂, K_{0.5}Ni_{0.25}Mn_{0.75}O₂, K_{0.4}Ni_{0.2}Mn_{0.8}O₂, K_{0.4}Ni_{0.2}Mn_{0.6}Ti_{0.2}O₂, K_{0.4}Ni_{0.2}Mn_{0.7}Ti_{0.1}O₂, K_{0.4}Ni_{0.2}Mn_{0.75}Ti_{0.05}O₂, K_{0.4}Fe_{0.4}Mn_{0.6}O₂, K_{0.4}Ni_{0.1}Mn_{0.9}O₂, K_{0.4}MnO₂, K_{0.3}Ni_{0.15}Mn_{0.85}O₂, K_{0.3}Ni_{0.2}Mn_{0.8}O₂, K_{0.3}Mn_{0.2}, K_{0.2}Ni_{0.1}Mn_{0.9}O₂, K_{0.2}Ni_{0.2}Mn_{0.8}O₂, K_{0.2}Mn_{0.2}, K_{0.1}Ni_{0.05}Mn_{0.95}O₂, K_{0.1}Ni_{0.1}Mn_{0.9}O₂, and a combination of at least two thereof.

13. The electrode material of claim 12, wherein the layered potassium metal oxide is K_{0.4}Ni_{0.2}Mn_{0.8}O₂.

14. The electrode material of claim 12, wherein the layered potassium metal oxide is K_{0.4}Ni_{0.2}Mn_{0.6}Ti_{0.2}O₂.

15. The electrode material of claim 12, wherein the layered potassium metal oxide is K_{0.4}Ni_{0.2}Mn_{0.75}Ti_{0.05}O₂.

16. The electrode material of claim 12, wherein the layered potassium metal oxide is K_{0.4}Fe_{0.4}Mn_{0.6}O₂.

17. An electrode material comprising an electrochemically active material, said electrochemically active material comprising a layered potassium metal oxide of formula Na_{z}KₓMO₂, wherein x is a number such that 0<x≤0.7, z is a number such that 0<x≤0.8, and M is selected from Co, Mn, Fe, Ni, Ti, Cr, V, Cu, Zr, Sb, and a combination of at least two thereof.

18. The electrode material of claim 17, wherein the electrochemically active material comprises a layered potassium metal oxide of formula Na_{z}KₓM_{y}Mn_{1-y}O₂, wherein x and z are as defined in claim 17, y is a number such that 0≤y≤1.0, and M is selected from Co, Fe, Ni, Ti, Cr, V, Cu, Zr, Sb, and a combination of at least two thereof.

19. The electrode material of claim 17 or 18, wherein the layered potassium metal oxide is of formula Na_{z}KₓNi_{y}Mn_{1-y}O₂, wherein x and z are as defined in claim 17, and y is a number such that 0≤y≤1.0.

20. The electrode material of any one of claims 17 to 19, wherein the layered potassium metal oxide is selected from the group consisting of Na_{0.74}K_{0.08}Ni_{0.41}Mn_{0.59}O₂, Na_{0.6}K_{0.08}Ni_{0.34}Mn_{0.66}O₂, Na_{0.74}K_{0.08}Ni_{0.2}Mn_{0.8}O₂, Na_{0.6}K_{0.08}Ni_{0.2}Mn_{0.8}O₂, Na_{0.32}K_{0.08}Ni_{0.2}Mn_{0.8}O₂, Na_{0.2}K_{0.2}Ni_{0.2}Mn_{0.8}O₂, and a combination of at least two thereof.

21. The electrode material of claim 20, wherein the layered potassium metal oxide is Na_{0.74}K_{0.08}Ni_{0.41}Mn_{0.59}O₂.

22. The electrode material of claim 20, wherein the layered potassium metal oxide is Na_{0.6}K_{0.08}Ni_{0.34}Mn_{0.66}O₂.

23. The electrode material of claim 20, wherein the layered potassium metal oxide is Na_{0.74}K_{0.08}Ni_{0.2}Mn_{0.8}O₂.

24. The electrode material of claim 20, wherein the layered potassium metal oxide is Na_{0.6}K_{0.08}Ni_{0.2}Mn_{0.8}O₂.

25. The electrode material of claim 20, wherein the layered potassium metal oxide is Na_{0.32}K_{0.08}Ni_{0.2}Mn_{0.8}O₂.

26. The electrode material of claim 20, wherein the layered potassium metal oxide is Na_{0.2}K_{0.2}Ni_{0.2}Mn_{0.8}O₂.

27. The electrode material of any one of claims 1 to 26, further comprising an electronically conductive material.

28. The electrode material of claim 27, wherein the electronically conductive material is selected from the group consisting of carbon black, acetylene black, graphite, graphene, carbon fibers, carbon nanofibers, carbon nanotubes, and a combination of at least two thereof.

29. The electrode material of claim 28, wherein the electronically conductive material comprises carbon fibers.

30. The electrode material of claim 29, wherein the carbon fibers are vapor grown carbon fibers (VGCF).

31. The electrode material of claim 28, wherein the electronically conductive material comprises carbon black.

32. The electrode material of claim 31, wherein the carbon black is Super P™ carbon.

33. The electrode material of claim 31, wherein the carbon black is Ketjen™ carbon.

34. The electrode material of any one of claims 1 to 33, further comprising a binder.

35. The electrode material of claim 34, wherein the binder is selected from the group consisting of a polymeric binder of polyether type, a fluorinated polymer, and a water-soluble binder.

36. The electrode material of claim 35, wherein the binder is a fluorinated polymer selected from polyvinylidene fluoride (PVDF), and polytetrafluoroethylene (PTFE).

37. The electrode material of claim 36, wherein the binder is polyvinylidene fluoride (PVDF).

38. The electrode material of claim 35, wherein the binder is a polymeric binder of polyether type.

39. The electrode material of claim 38, wherein the polymeric binder of polyether type is branched and/or crosslinked.

40. The electrode material of claim 38 or 39, wherein the polymeric binder of polyether type is a polyethylene oxide (PEO)-based polymer.

41. An electrode comprising an electrode material as defined in any one of claims 1 to 40 on a current collector.

42. The electrode of claim 41, wherein the electrode is a positive electrode.

43. An electrochemical cell comprising a negative electrode, a positive electrode, and an electrolyte, wherein the positive electrode is as defined in claim 41 or 42.

44. The electrochemical cell of claim 43, wherein the negative electrode comprises lithium metal, sodium metal, potassium metal, or an alloy comprising at least one of these.

45. The electrochemical cell of claim 43, wherein the negative electrode comprises at least one of a prelithiated alloy, a prelithiated graphite, a prelithiated silicon, a prelithiated oxide, or a combination of at least two thereof.

46. The electrochemical cell of claim 43, wherein the negative electrode comprises at least one of a presodiated alloy, a presodiated hard carbon, and a presodiated oxide.

47. The electrochemical cell of claim 43, wherein the negative electrode comprises at least one of a prepotassiated alloy, a prepotassiated graphite, a prepotassiated hard carbon, and a prepotassiated oxide.

48. The electrochemical cell of any one of claims 43 to 47, wherein the electrolyte is a liquid electrolyte comprising a salt in a solvent.

49. The electrochemical cell of any one of claims 43 to 47, wherein the electrolyte is a gel electrolyte comprising a salt in a solvent and optionally a solvating polymer.

50. The electrochemical cell of any one of claims 43 to 47, wherein the electrolyte is a solid polymer electrolyte comprising a salt in a solvating polymer.

51. The electrochemical cell of any one of claims 48 to 50, wherein the salt is selected from a lithium salt, a sodium salt, a potassium salt, and a combination of at least two thereof.

52. The electrochemical cell of any one of claims 48 to 51, wherein the salt is a lithium salt.

53. The electrochemical cell of claim 52, wherein the lithium salt is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiN_{0.3}), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate [B(O₆O₂)_{2]} (LiBBB), and a combination of at least two thereof.

54. The electrochemical cell of claim 52 or 53, wherein the lithium salt is selected from LiPF₆, LiFSI, LiTFSI, LiTDI, and a combination of at least two thereof.

55. The electrochemical cell of any one of claims 48 to 51, wherein the salt is a sodium salt.

56. The electrochemical cell of claim 55, wherein the sodium salt is selected from sodium hexafluorophosphate (NaPF₆), sodium perchlorate (NaClO₄), sodium bis (trifluoromethanesulfonyl) imide (NaTFSI), sodium bis(fluorosulfonyl)imide (NaFSI), sodium 2-trifluoromethyl-4,5-dicyanoimidazolate (NaTDI), sodium bis (pentafluoroethylsulfonyl) imide (NaBETI), sodium trifluoromethanesulfonate (NaTF), sodium fluoride (NaF), sodium nitrate (NaNO₃), and a combination of at least two thereof.

57. The electrochemical cell of claim 55 or 56, wherein the sodium salt is selected from NaPF₆, NaFSI, NaTFSI, NaClO4, and a combination of at least two thereof.

58. The electrochemical cell of any one of claims 48 to 51, wherein the salt is a potassium salt.

59. The electrochemical cell of claim 58, wherein the potassium salt is selected from potassium hexafluorophosphate (KPF₆), potassium bis (trifluoromethanesulfonyl) imide (KTFSI), potassium bis(fluorosulfonyl)imide (KFSI), potassium trifluoromethanesulfonate (KSO₃CF₃) (KTf), and a combination of at least two of these.

60. The electrochemical cell of claim 58 or 59, wherein the potassium salt is KPF₆.

61. The electrochemical cell of any one of claims 43 to 47, wherein the electrolyte is a glass or ceramic electrolyte.

62. The electrochemical cell of claim 61, wherein the electrolyte is a glass or ceramic electrolyte selected from a site-deficient perovskite-type electrolyte, a garnet-type electrolyte, a NASICON-type glass ceramic electrolyte, a LISICON-type electrolyte, a lithium-stabilized sodium ion (Na⁺) conducting aluminum oxide (Al₂O₃), and other similar glass or ceramic electrolytes.

63. A battery comprising at least one electrochemical cell as defined in any one of claims 43 to 62.

64. The battery of claim 63, wherein said battery is selected from the group consisting of a lithium battery, a lithium-ion battery, a sodium battery, a sodium-ion battery, a potassium battery, and a potassium-ion battery.

65. The battery of claim 63 or 64, wherein said battery is a lithium-ion battery.

66. The battery of claim 63 or 64, wherein said battery is a sodium-ion battery.

67. The battery of claim 63 or 64, wherein said battery is a potassium-ion battery.
